(19) United States
(12) Patent Application Publication
(10) Pub. No.: US 2009/0291286 A1
(43) Pub. Date: Nov. 26, 2009

(54) Laminate manufacturing system, method, and article of manufacture

(76) Inventor: Ziming Shen, Staten Island, NY (US)

Correspondence Address: Alfred Walker, 225 Old Country Road, Melville, NY, 11747, US

(21) Appl. No.: 12/380,928

(22) Filed: Mar. 4, 2009

Related U.S. Application Data
(60) Provisional application No. 61/068,156, filed on Mar. 4, 2008.

(51) Int. Cl. B32B 5/16; B32B 38/04; B32B 23/00

(52) U.S. Cl. 428/220; 156/220; 156/390; 156/511; 428/326; 428/292.4

(57) ABSTRACT

A laminate manufacturing system, method, and article of manufacture, the article of manufacture having a core of fresh or green wood and/or recycled wood products, processed down to a particle size of less than 5 mm, and preferably less than 3 mm, and bonded together with glue, opposing surface inner veneer bonded to opposing surfaces of the core with glue, opposing surface outer veneer bonded to opposing surface inner veneer with glue, opposing edge veneer bonded to opposing edges of the core with glue. Each of the veneers is preferably 0.5 mm thick, although suitable veneer thicknesses may range from 0.3 to 0.5 mm. The article of manufacture thus produced is a laminated wood product having a particle to glue ratios that provides a durable, lightweight, strong attractive product that gives the appearance of wood.

### RELATED APPLICATIONS

This application is based in part upon provisional application Ser. No. 61/068,156, filed Mar. 4, 2008, which application is incorporated by reference herein. Applicant claims benefit of 25 U.S.C, § 119 (e) and priority therefrom.

### BACKGROUND OF THE INVENTION

1. Field of the Invention

The present invention relates generally to wood manufacturing systems, methods, and products and more particularly to wood and renewable product laminate manufacturing systems, methods, and durable, lightweight but strong articles of manufacture.

2. Background Art

A variety of products, including furniture, home décor, children's furniture, educational furniture, toys, and teaching aids in today's world markets, especially American and European and markets, and in particular the North American market, are often produced from artificial multi-birch plywood.

Birch is a key component and preferred product in fabricating many of the above referred to products, furniture, home décor, children's furniture, educational furniture, toys, and teaching aids, and as a result of the increased demand for these items, demand for birch has increased, pushing up prices, and stressing the environment, especially in light of birch's long growth cycle. Extensive logging has caused serious ecological damage and increased costs of manufacturing multi-birch plywood, while the demand for birch is ever increasing.

For the foregoing reasons, there is a need for a manufacturing system, method, and durable, lightweight, strong article of manufacture that reduces the demand for birch, and, thus, relieves some stress on the environment and ecosystem, while reducing costs of the ultimate product being manufactured. The manufacturing system, method, and article of manufacture should not only reduce the demand for birch and prevent damage to the world's ecological balance, use and reuse renewable materials, and use resource recovery to greatly reduce the demand for logs. The manufacturing system, method, and article of manufacture should greatly reduce the cost of production, and satisfy North American and European and American market demand for birch plywood products.

The manufacturing system, method, and article of manufacture should be capable of producing a durable, lightweight, strong laminated product that has the appearance of traditional birch plywood. The laminated article of manufacture should have an interior similar to that of particle board, but the laminated article of manufacture should have increased strength and lighter weight compared to that of other particle boards. Additionally, the laminated article of manufacture should be capable of having at least one or a plurality of thin or ultra-thin veneers placed on opposing surfaces and opposing edges, and be capable of being painted. The laminated article of manufacture should be capable of being manufactured from recycled biodegradable products.

Present day fireproof products are often coated with a fire retardant material on the exterior or the veneer of such product, which does not result in fully fireproofing the product through-and-through, nor do present methods result in a high degree of fireproofing The laminated article of manufacture should be capable of being fully fireproofed through-and-through and be capable of having wood preservatives added thereto to extend life of the product. Such laminated articles of manufacture that are fireproofed through-and-through should be capable of being used in fireproof doors, firewall supplies, and the like.

The manufacturing system, method, and article of manufacture should be inexpensive and capable of being fabricated in a quick, convenient, and efficient manner, and the laminated article of manufacture should be durable, light weight, strong, inexpensive, safe to use, attractive, sturdy, and of simple construction.

### SUMMARY

The present invention is directed to a manufacturing system, method, and article of manufacture that reduces the demand for birch, and, thus, relieves stress on the environment and ecosystem, while reducing costs of the ultimate product being manufactured. The manufacturing system, method, and article of manufacture is capable of not only reducing the demand for birch and preventing damage to the world's ecological balance, but uses and reuses renewable materials, and uses resource recovery to greatly reduce the demand for logs. The manufacturing system, method, and article of manufacture greatly reduces the cost of production, and satisfies North American and European and American market demand for birch plywood products.

The article of manufacture thus produced is a laminate panel of particle board of particular particle size and particle to glue ratios which provides a durable, lightweight and strong panel which gives the appearance of wood because its exterior veneer layer or layers are made from a thin wood veneer of approximately 0.35 to 0.70 millimeters in thickness. A preferable veneer thickness is 0.5 mm, although veneer thicknesses may range from 0.3 to 0.5 mm, although other suitable thicknesses may be used.

To keep the wood lightweight, the particles should be more than 1.0 mm and less than 5.0 mm in length, depth and width, preferably about 3.0 mm in length, depth and width so that they are small enough to have sufficient density for strength, but large enough to provide air spaces therebetween, to be filled by resin glue at a weight lighter than natural wood. The ratio of wood particles to glue should be preferably 100:10 to 100:12, i.e. 100 kg of raw wood particle material to mix with 10-12 kg of glue. The maximum permitted is 100:28, i.e. 100 kg wood particle to 28 gms glue. With the aforementioned parameters, the finished particle board density is 0.8 g/cm³. To keep the panels smooth and flat, sanding should be applied to keep height deviation within 0.1 mm. Also, to have sufficient glue without undue buildup or air bubbles, glue should be applied in the ratio of 320 g/m². To further keep the panels smooth, the thin veneer layers with glue are heat and pressure treated at 110 C and pressure of about 1 cm² per 7-8 kg. On the edges, veneer strips of about 1.5 cm in with and 0.5 to about 1 mm in thickness, with lengths of 1 meter or more, are applied at a pressure of approximately 200 pounds with a glue at approximately 200 degrees C. heat. For fireproofing, insect proofing or water proofing, a thin layer of Wood Fire Resisting Liquid is applied by putting the panels in a tank full of liquid of pressure more than 1.2 Mp³P for at least 8 hours immersion, which will soak about 150 kg/cubic meter of product into the wood. At low ambient pressure, the wood must be soaked for at least 48 hours, as long as 80 to 100 kg/cubic meter is absorbed into the wood over the 48 hour period. Exterior brushing can also be applied in three layer coatings to a thickness of 0.5 kg/cubic meter. Although other fire resistant, water resistant and pest or mold resistant sealers can be applied, a typical fire resistant liquid wood sealer is described, for example, in U.S. Pat. No. 5,879,593, including a liquid composition of potassium hydroxide, sodium carbonate, silica and water.

The manufacturing system, method, and article of manufacture is capable of producing a laminated product that has the appearance of traditional birch plywood. The laminated article of manufacture has an interior similar to that of particle board, but the laminated article of manufacture should has increased strength and lighter weight compared to that of other particle boards. Additionally, the laminated article of manufacture is capable of having at least one or a plurality of thin or ultra-thin veneers placed on opposing surfaces and opposing edges, and is capable of being painted. The laminated article of manufacture is capable of being manufactured from recycled biodegradable products.

In the U.S. and Europe, the natural color of a natural wood surface having a clear coat with the texture of the wood showing through is highly desirable, especially that of Birch Wood grown in Northern Asia, (Northern China and Russia). Birch wood also has characteristics of surface hardness, beautiful texture, a minimum amount of scar marks, black lines, or mineral lines, does not easily break or change shape after having been cut in the format of veneer sheet (usually in the size of 4 feet by 8 feet, 0.3 mm to 0.5 mm in thickness), but these high quality veneers are becoming less and less available, because a 3 foot or larger diameter birch tree takes more than 60 years to grow, and there are only 3 to 5 sheets of 4 feet by 8 feet veneers in that tree. These 3 to 5 sheets of veneers, may be used on surfaces of 4 feet by 8 feet plywood, and used for the manufacture of 5 storage units for toys. One class room of furniture, however, needs at least 5 times of this amount of veneer, which means that a classroom's furniture needs five birch trees to manufacture the furniture.

The present invention's unique system may be used instead of using birch veneer. Chinese Cottonwood (called Chinese Birch or Chinese beech) which grows on tree farms and takes approximately 7-10 years to grow, and which grows into a one and half foot diameter tree may be used. Veneers from these trees, however, have soft surfaces that may scratch easily. However, such veneers may be hardened by methods of the present invention, resulting in finished products that look substantially the same as Russian Birch, or other highly desired woods.

By using the above wood materials and paint processes of the present invention, wood products can be made completely of recycled wood and veneers from fast growing Chinese trees, thus, minimizing impact to the environment.

Present day fireproof products are often coated with a fire retardant material on the exterior or the veneer of such product, which does not result in fully fireproofing the product through-and-through, nor do present methods result in a high degree of fireproofing The laminated article of manufacture is capable of being fully fireproofed through-and-through and is capable of having wood preservatives added thereto to extend life of the product. Such laminated articles of manufacture that are fireproofed through-and-through are capable of being used in fireproof doors, firewall supplies, and the like.

The manufacturing system, method, and article of manufacture is inexpensive and capable of being fabricated in a quick, convenient, and efficient manner, and the laminated article of manufacture is durable, light weight, strong, inexpensive, safe to use, attractive, sturdy, and of simple construction.

A article of manufacture having features of the present invention comprises: a core of fresh or green wood and/or recycled wood products, processed down to a particle size of less than 5 mm, and preferably less than 3 mm, and bonded together with glue, opposing surface inner veneer bonded to opposing surfaces of the core with glue, opposing surface outer veneer bonded to opposing surface inner veneer with glue, opposing edge veneer bonded to opposing edges of the core with glue. Each of the veneers is preferably 0.5 mm thick, although suitable veneer thicknesses may range from 0.3 to 0.5 mm. The article of manufacture thus produced is a laminated wood product having a particle to glue ratios that provides a durable, lightweight, strong attractive product that gives the appearance of wood.

### DRAWINGS

These and other features, aspects, and advantages of the present invention will become better understood with regard to the following description, appended claims, and accompanying drawings where:

FIG. 1 is a side cross section view of a laminated wood product, constructed in accordance with the present invention;

FIG. 2 is a side cross section view of an alternate laminated wood product, constructed in accordance with the present invention;

FIG. 3 is a schematic representation of steps of a method for manufacturing the laminated wood product of FIG. 1;

FIG. 4 is a schematic representation of other steps of the method for manufacturing the laminated wood product of FIG. 1;

FIG. 4A is a schematic representation of other steps of the method for manufacturing the laminated wood product of FIG. 1;

FIG. 5 is a schematic representation of an industrial process for manufacturing the laminated wood product of FIG. 1;

FIG. 5A is a continuation of the schematic representation of the industrial process for manufacturing the laminated wood product of FIG. 5;

FIG. 6 depicts a wood chipper of the industrial process for manufacturing the laminated wood product of FIG. 1;

FIG. 7 depicts an optional planing machine of the industrial process for cutting large pieces of wood before cutting the wood into wood chips, manufacturing the laminated wood product of FIG. 1;

FIG. 8 depicts a heating and drying machine of the industrial process for manufacturing the laminated wood product of FIG. 1;

FIG. 9 depicts a double swing screen of the industrial process for manufacturing the laminated wood product of FIG. 1;

FIG. 10 depicts a ring blending machine of the industrial process for manufacturing the laminated wood product of FIG. 1;

FIG. 11 depicts a roller-plate pre-press machine of the industrial process for manufacturing the laminated wood product of FIG. 1;

FIG. 12 depicts a glue coating machine of the industrial process for manufacturing the laminated wood product of FIG. 1;

FIG. 13 depicts a heat pressing veneering machine of the industrial process for manufacturing the laminated wood product of FIG. 1

FIG. 14 depicts a vertical and horizontal edge cutting machine of the industrial process for manufacturing the laminated wood product of FIG. 1;

FIG. 15 is a front perspective view of an edge bonding machine of the industrial process for applying hot melt adhesive for manufacturing the laminated wood product of FIG. 1;

FIG. 16 is a top perspective view of the edge bonding machine of FIG. 15 for the application of hot melt adhesive of the industrial process for manufacturing the laminated wood product of FIG. 1;

FIG. 17 is an exploded view of a machine with a rolled edge veneer strip ready to be applied to one of a core of the laminated wood product of FIG. 1;

FIG. 17A depicts the machine for applying the rolled edge veneer strip of FIG. 17 ready to be applied to one of a core of the laminated wood product of FIG. 1;

FIG. 18 depicts a core to be laminated with the edge veneer strip of the laminated wood product of FIG. 1;

FIG. 19 depicts a laminated core of the laminated wood product of FIG. 1 being applied on edge of the core;

FIG. 20 also depicts a laminated core of the laminated wood product of FIG. 1 with a veneer strip which has been edge cut;

FIG. 21 also depicts a laminated core of the laminated wood product of FIG. 1 being rotated for application of a second veneer strip thereto;

FIG. 22 depicts a second veneer strip applied to the laminated core of the laminated wood product of FIG. 1;

FIG. 23 depicts a third edge veneer strip being applied to edges of the core of the laminated wood product of FIG. 1;

FIG. 24 depicts a further edge veneer strip being applied to the edges of a laminated core of the laminated wood product of FIG. 1;

FIG. 25 depicts a perspective view of a finished laminated core of the laminated wood product of FIG. 1 having four edge veneer strips applied thereto;

FIG. 26 depicts another perspective view of a finished laminated core of the laminated wood product of FIG. 1 having the four edge veneer strips applied thereto;

FIG. 27 depicts another perspective view of a finished laminated core of the laminated wood product of FIG. 1 having the four edge veneer strips applied thereto;

FIG. 28 shows an optional tank for dipping and soaking the laminate wood product of FIG. 1 into a pool of fire proof fluid, wherein the laminate wood product is shown being dipped into the pool in the direction of the directional arrow “A”.

FIG. 28A depicts an adhesive coating machine of the industrial process for manufacturing the fire proofed laminated wood product of FIG. 28;

FIG. 29 depicts a pre-press machine of the industrial process for manufacturing the laminated wood product of FIG. 28;

FIG. 30 depicts chipped wood step 104 of FIG. 3 of the industrial process for manufacturing the laminated wood product of FIG. 1;

FIG. 31 depicts the chipped wood of the industrial process for manufacturing the laminated wood product of FIG. 1 being introduced onto a conveyor to be transported to a heating and drying machine;

FIG. 32 depicts a mixer and a conveyor of the industrial process for manufacturing the laminated wood product of FIG. 1;

FIG. 33 depicts a further mixer of the industrial process for manufacturing the laminated wood product of FIG. 1;

FIG. 34 depicts a heater-dryer and a conveyor and of the industrial process for manufacturing the laminated wood product of FIG. 1;

FIG. 35 depicts a conveyor introducing particles into a double swing screen similar to that of FIG. 9, of the industrial process for sifting particles by particle size for manufacturing the laminated wood product of FIG. 1;

FIG. 35A depicts the double swing screen of FIG. 35;

FIG. 36 depicts a collector of the industrial process for collecting the sifted particles of FIGS. 35 and 35A for manufacturing the laminated wood product of FIG. 1;

FIG. 37 depicts a feeder-spreader of the industrial process for manufacturing the laminated wood product of FIG. 1;

FIG. 38 depicts a roller plate press machine similar to roller press 222 of FIG. 11, of the industrial process for manufacturing the laminated wood product of FIG. 1;

FIG. 39 depicts a pressing machine of the industrial process for manufacturing the laminated wood product of FIG. 1;

FIG. 40 depicts a sander of the industrial process for manufacturing the laminated wood product of FIG. 1;

FIG. 41 is a perspective view of a core of an alternate embodiment for a laminated wood product with longitudinally extending wood strips embedded therein.

### DESCRIPTION

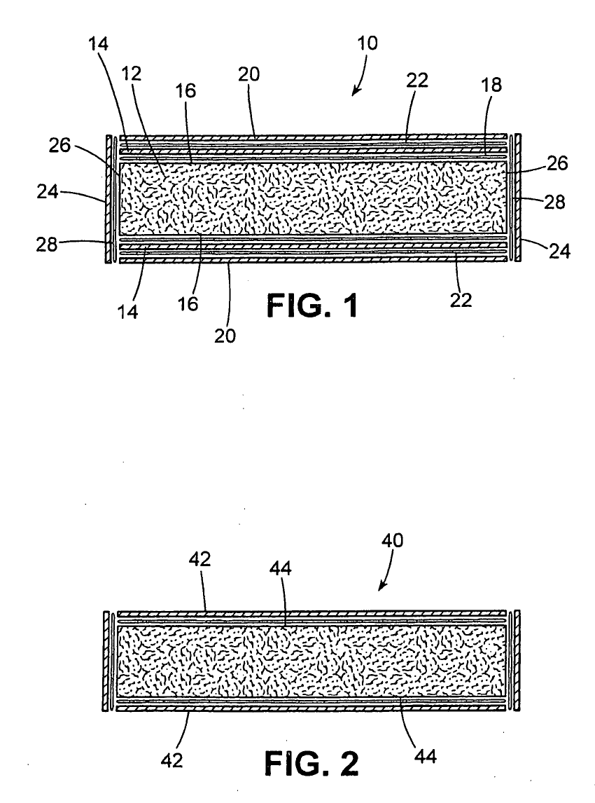

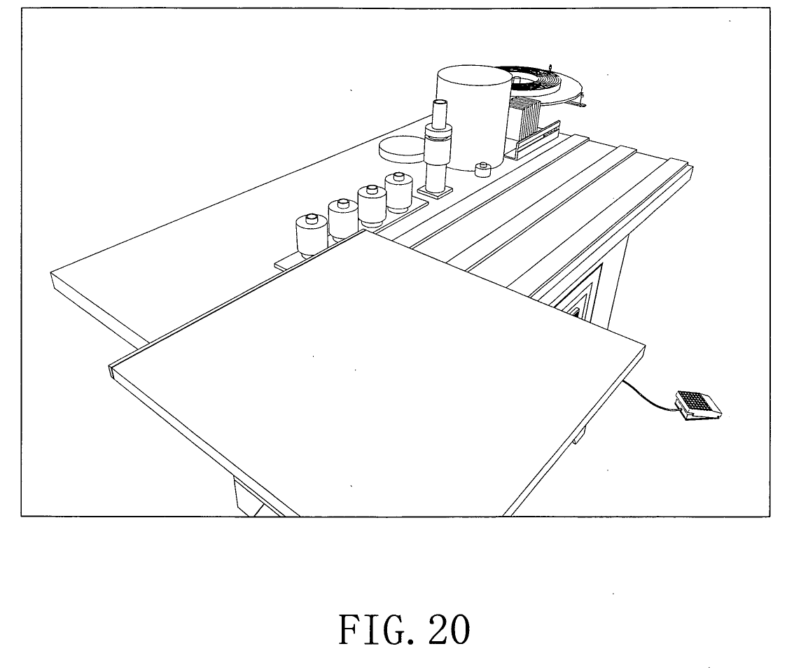

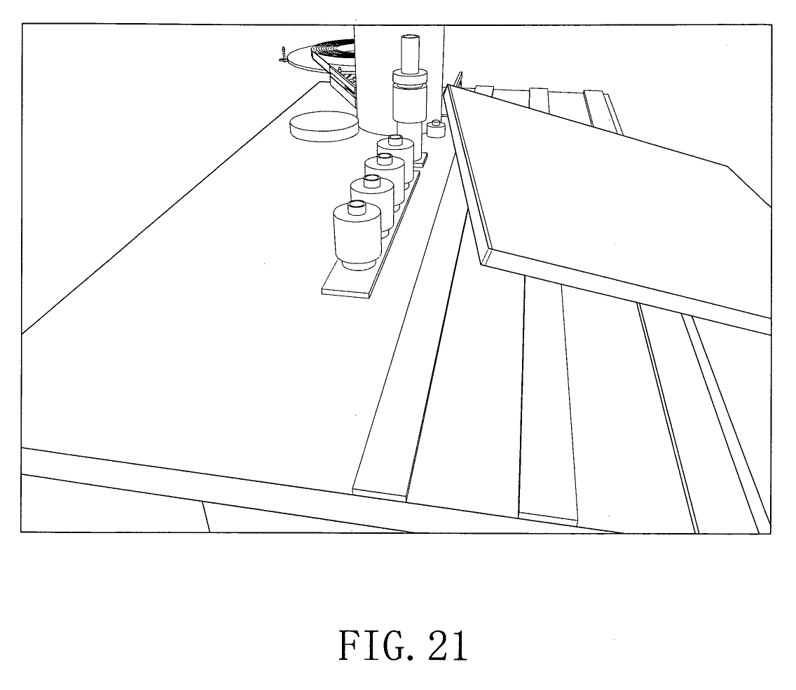

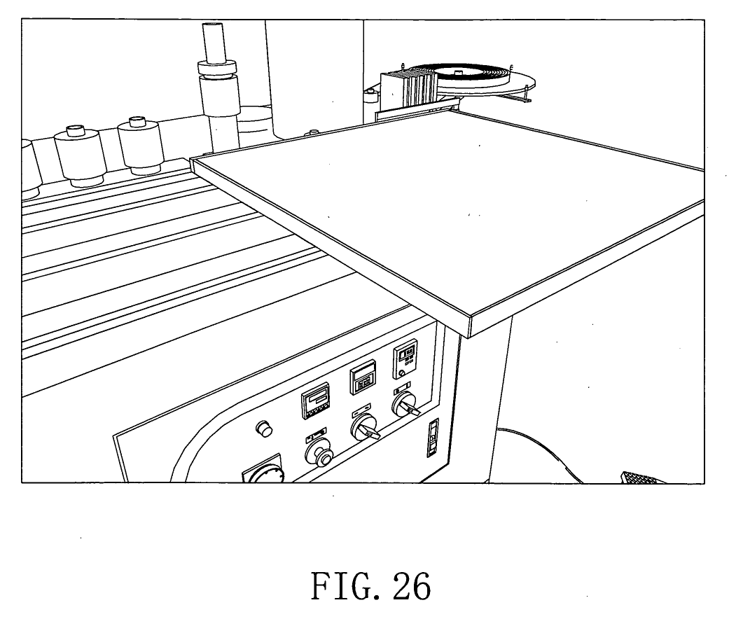

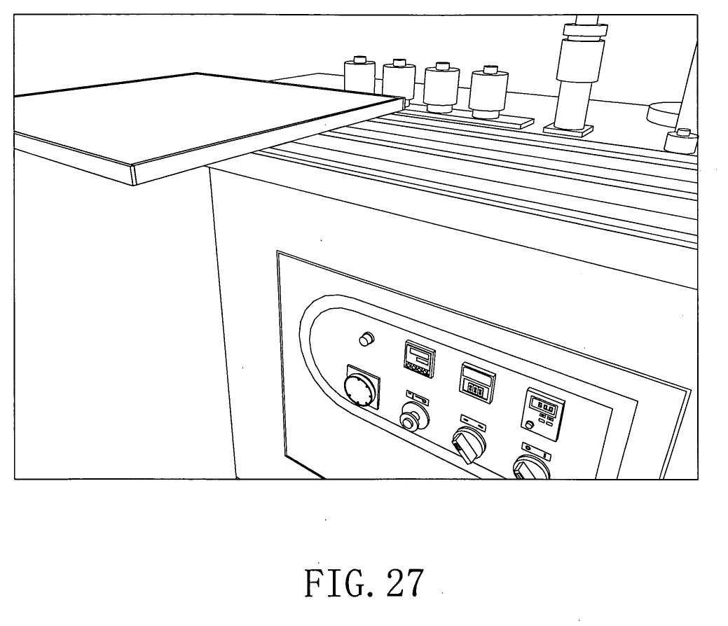

The preferred embodiments of the present invention will be described with reference to FIGS. 1-40 of the drawings. Identical elements in the various figures are identified with the same reference numbers.

FIG. 1 shows a laminated wood product 10, constructed in accordance with the present invention, having a core 12 of fresh or green wood and/or recycled wood products, processed down to a particle size of less than 5 mm, and preferably less than 3 mm, and bonded together with glue, opposing surface inner veneer 14 bonded to opposing surfaces 16 of the core 12 with glue 18, opposing surface outer veneer 20 bonded to opposing surface inner veneer 14 with glue 22, opposing edge veneer 24 bonded to opposing edges 26 of the core 12 with glue 28.

El urea-formaldehyde glue having formaldehyde emission of less than or equal to 9 mg/100 g is preferably used to meet environmental and safety standards, particularly for the North American and European markets, and more particularly for furniture safety and children's furniture safety.

FIG. 2 shows an alternate embodiment of a laminated wood product 40, constructed in accordance with the present invention; which is substantially the same as the laminated wood product 10, except that the alternate embodiment of the laminated wood product 40 has only one surface veneer 42 bonded to each of opposing surfaces 44 of the laminated wood product 40.

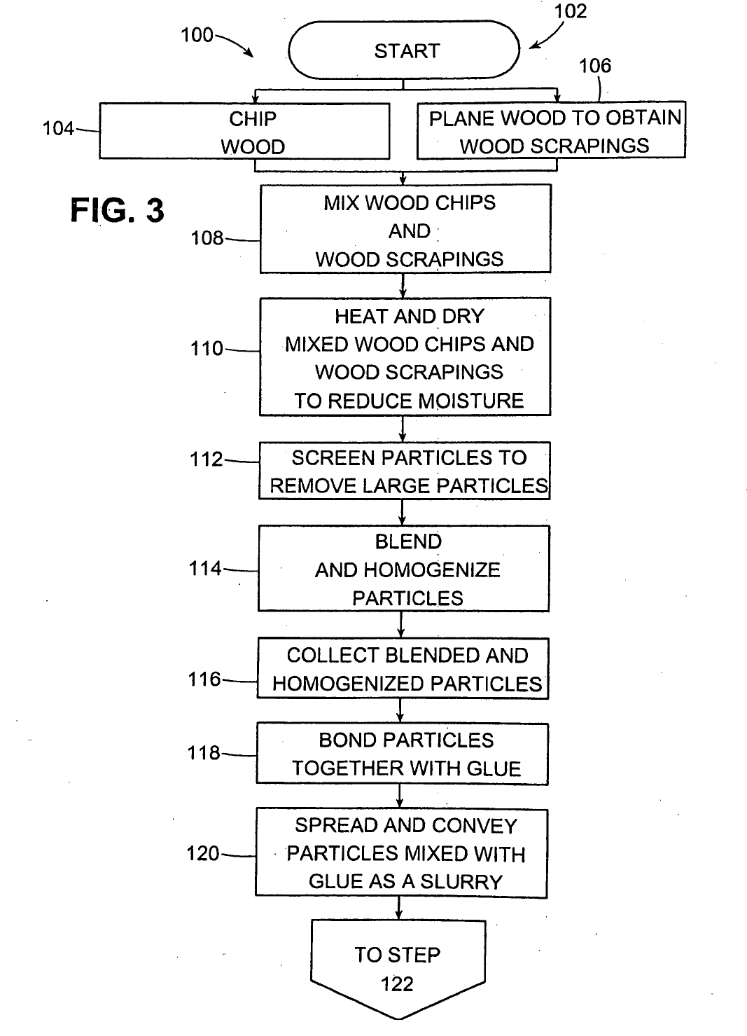

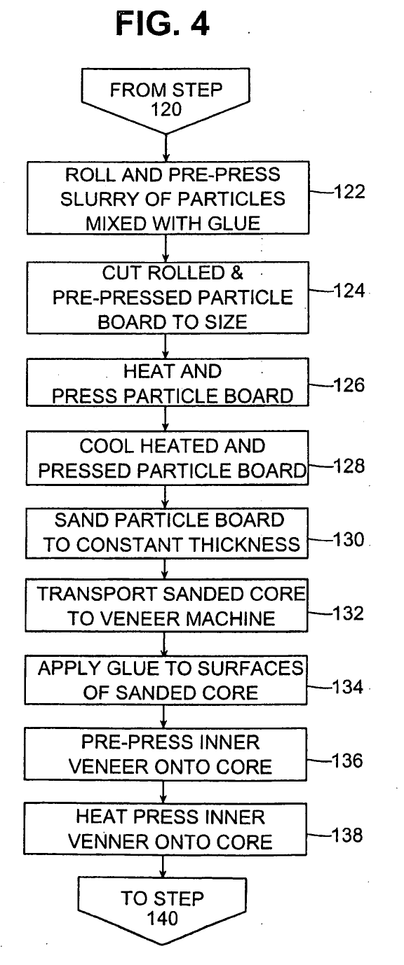

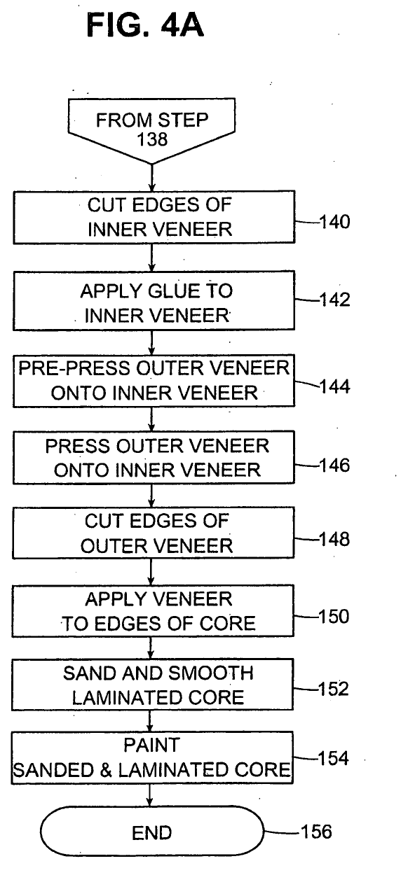

FIGS. 3, 4, and 4A show steps of a method 100 for manufacturing the laminated wood product of FIG. 1, which starts at step 102.

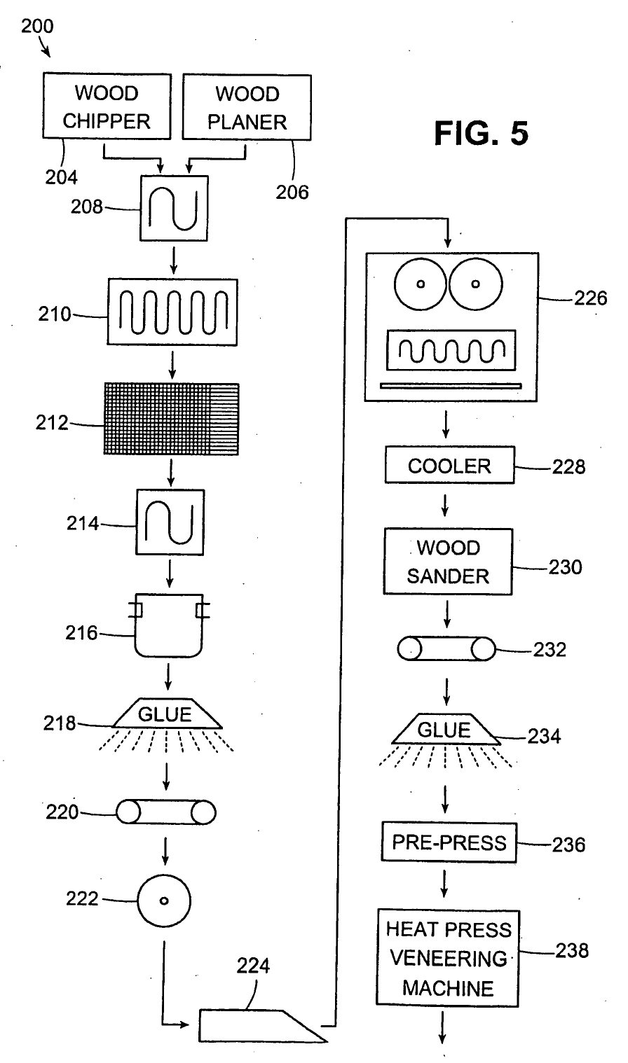

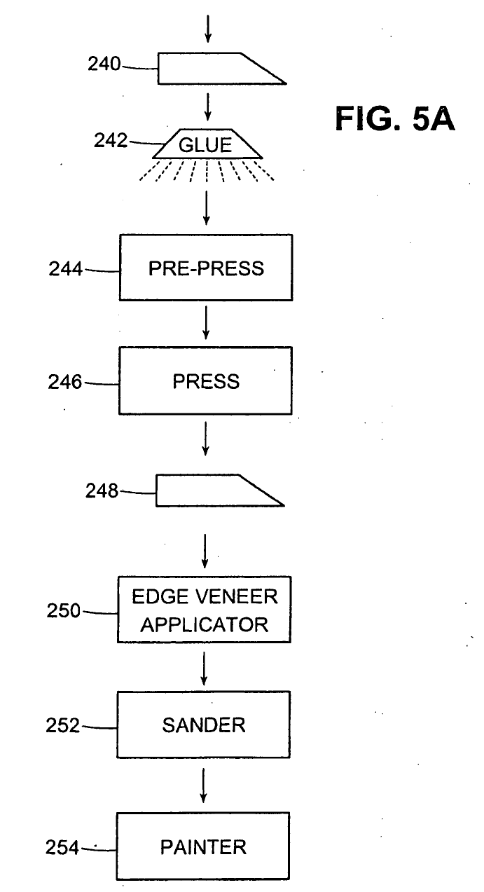

FIGS. 5 and 5A show an industrial process 200 for manufacturing the laminated wood product of FIG. 1.

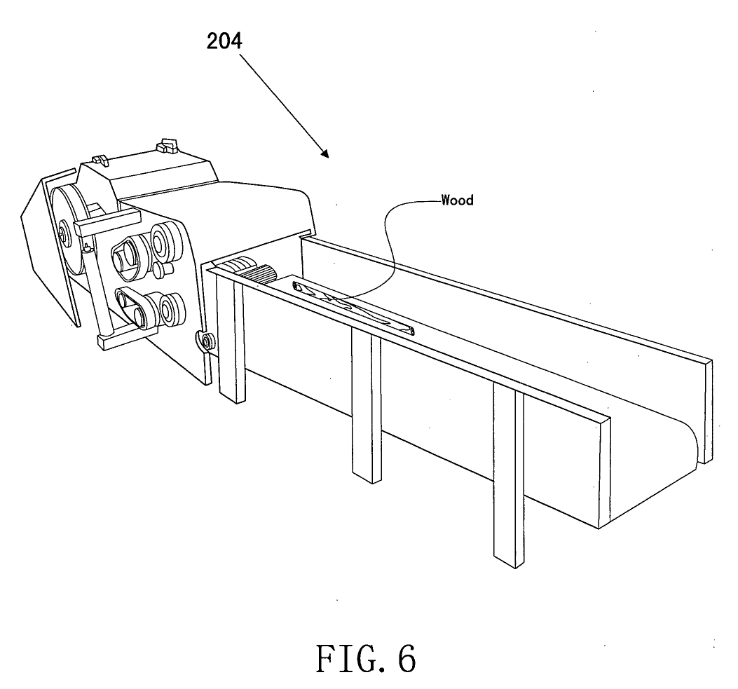

FIGS. 6-14 show equipment used in the industrial process of FIG. 5 for manufacturing the laminated wood product of FIG. 1.

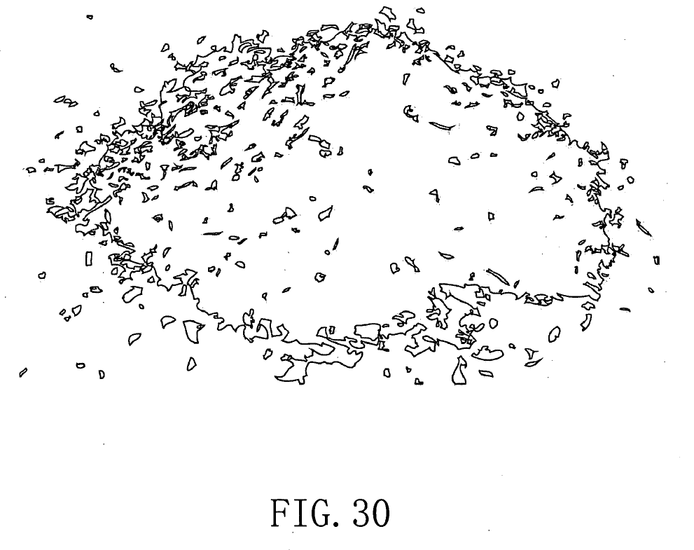

Now, in more detail, raw material for the core is obtained from waste, scrap wood, saw dust, various sawing, planing, scraping operations, plywood factories, and from tree branches, and sticks, which may be fresh wood and/or green wood. The raw material is placed in a wood chipper as shown at step 104 in FIG. 3, using a wood chipper 204 as shown in the industrial process drawing of FIG. 5, which is depicted in FIG. 6 as the wood chipper 204. More detailed views of the wood chipping process for forming the wood product 10 are shown in a preferred example shown in FIGS. 30-40.

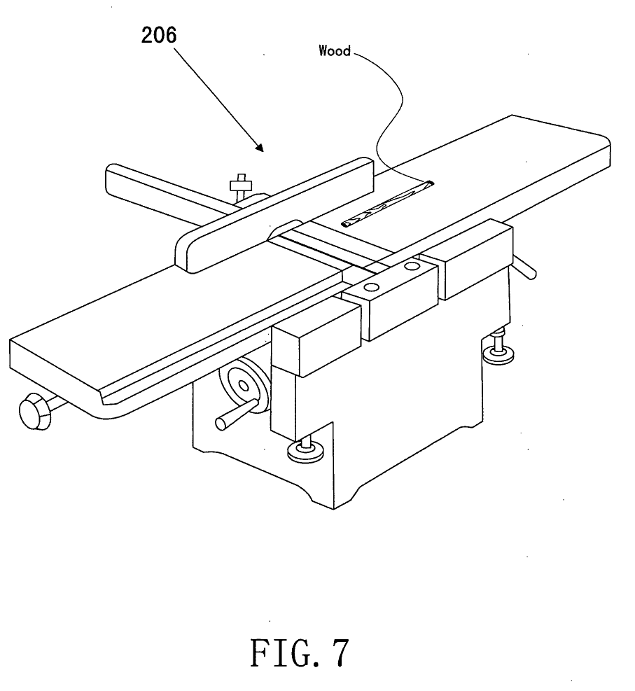

Optionally, or in addition to the wood chipping of FIG. 6, wood scrapings are generated with a planing machine 206 shown in FIG. 7, which chips and planes wood to particles less than 5 mm in length and width, shown at step 104 as planing wood in FIG. 3, and which is depicted in FIG. 5 as the planing machine 206.

The chipped and scraped wood are then mixed as shown at step 108 in FIG. 3, using a mixer 208 as shown in the industrial process drawing of FIG. 5, and then collected and temporarily stored in a storehouse until a large enough amount is available for heating and drying.

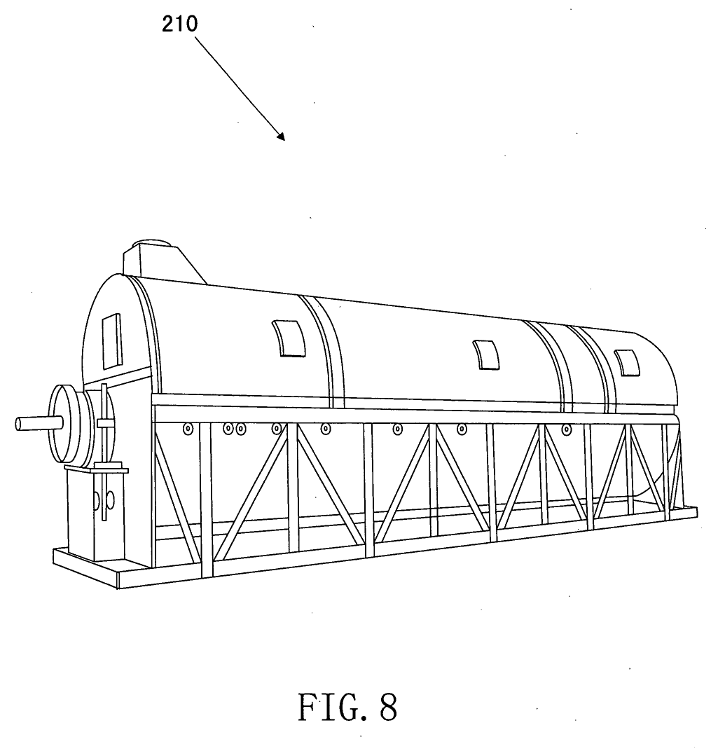

The mixed wood chips and scrapings are then heated and dried to reduce moisture as shown at step 110 in FIG. 3, using a rotary heating and drying machine 210 as shown in the industrial process drawing of FIG. 5, which is depicted in FIG. 8 as the heating and drying machine 210, the mixed wood chips having been sent from the storehouse to the rotary heating and drying machine 210 via a belt transmission for heating and drying.

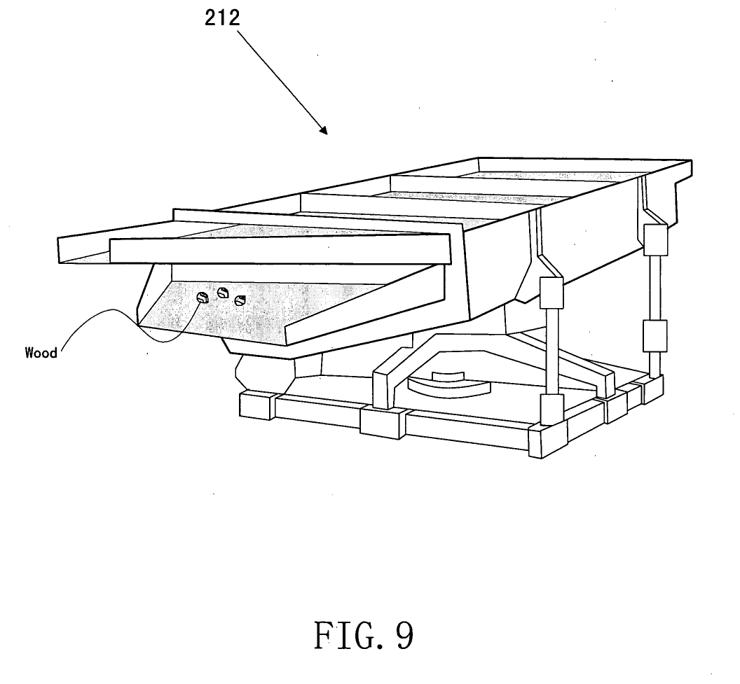

Upon heating and drying the mixed wood chips and scrapings and removing moisture from the mixed wood chips and scrapings to a moisture content of less than 12 percent, the resulting heated and dried particles are screened as shown at step 112 in FIG. 3 to remove particles larger than 5 mm, using a double swing screen 212 as shown in the industrial process drawing of FIG. 5, which is depicted in FIG. 9 as the double swing screen 212.

Particles larger than 5 mm are sent back to the wood chipper 204 and/or the planing machine 206, until the larger particles are reduced in size, and then collected and temporarily stored in the storehouse with other collected chipped wood and wood scrapings awaiting a large enough amount to become available for heating and drying.

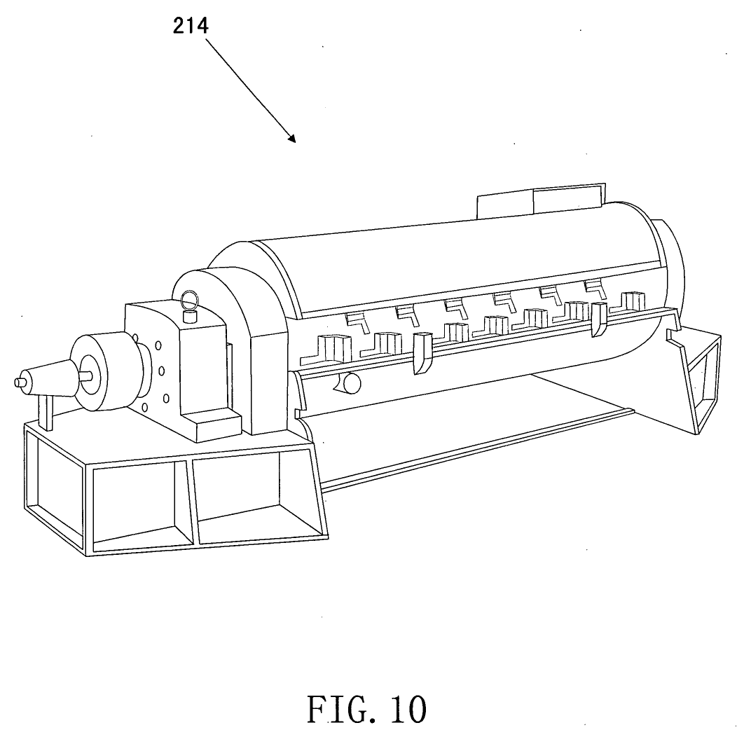

The screened particles are then blended in a blender to blend and homogenize the particles as shown at step 114 in FIG. 3, using a ring blending machine 214 as shown in the industrial process drawing of FIG. 5, which is depicted in FIG. 10 as the ring blending machine 214, to ensure uniformity of particle size throughout the mixture of particles and that bonding materials that will be used to bond the particles will adhere properly to the particles and bond the particles, as required.

The blended and homogenized particles are then collected as shown at step 116 in FIG. 3, using a collector 216 as shown in the industrial process drawing of FIG. 5.

The collected blended and homogenized particles are then mixed with bonding material, using glue as the bonding material, as shown at step 118 in FIG. 3, using a glue machine 218 as shown in the industrial process drawing of FIG. 5.

Typically, 10-12 kg of glue is mixed per 100 kg of blended and homogenized particles to bond the particles together. El urea-formaldehyde glue having formaldehyde emission of less than or equal to 9 mg/100 g is preferably used to meet environmental and safety standards, particularly for the North American and European markets, and more particularly for furniture safety and children's furniture safety.

The blended and homogenized particles having been mixed with glue as the bonding material is then spread in a slurry onto a rubber conveyer, the slurry being similar to that of a slurry of pavement spread on a road prior to compaction, and transported via an air-surfacing machine for pre-pressure molding in a roller-plate pre-press machine, as shown at step 120 in FIG. 3 as spreading and conveying the particles mixed with glue as a slurry to roller plates, using a spreader and conveyor 220 as shown in the industrial process drawing of FIG. 5.

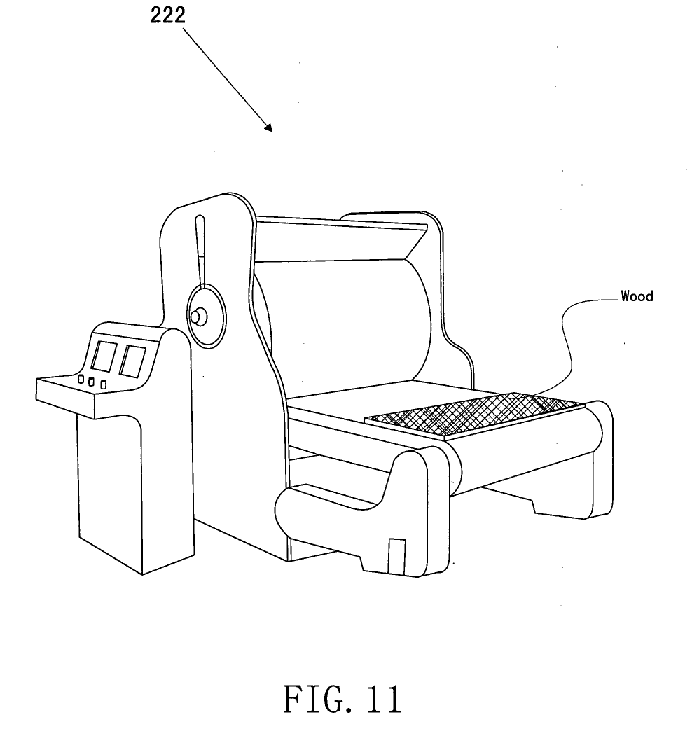

The slurry of particles mixed with glue is then rolled and pre-pressed as shown at step 122 in FIG. 4 into particle board, using a roller-plate pre-press machine 222 as shown in the industrial process drawing of FIG. 5, which is depicted in FIG. 11 as the roller-plate pre-press machine 222.

The rolled and pre-pressed particle board is then cut to size as shown at step 124 in FIG. 4, using a cutter 224 as shown in the industrial process drawing of FIG. 5, and then transported to a heat pressing machine for heating and pressure molding at step 126 of FIG. 4, the heating pressing machine 226 shown in the industrial process drawing of FIG. 5, which controls thickness of the core 12 of the laminated wood product 10 of the present invention.

In a preferred embodiment, the core is based on imitation birch for children's furniture production, and as a result its must be highly compressed and have a high glue content. The finished core or board density must be above 0.8 g/cm³.

The heat pressed particle board is then cooled, as shown at step 128 of FIG. 4, at a cooling plate machine 228 shown in the industrial process drawing of FIG. 5, as the heat pressed particle board is unloaded onto the cooling plate machine 228 from the heat press machine via an automatic unloading machine and is cooled for a period of time.

The cooled particle board is then sanded at step 130 of FIG. 4, using a wood sander 230 as shown in the industrial process drawing of FIG. 5, as the surfaces of the core 12 of the laminated wood product 10 of the present invention must be substantially smooth, the cooled particle board must be sanded to smooth the surfaces.

The surfaces of the core 12 of the laminated wood product 10 must be controlled within 0.1 mm, which is typically accomplished at the wood sander 230, using with 60 grit sand paper.

The sanded core is then transported to a heat press veneering machine at step 132 of FIG. 4, using a conveyor 232 as shown in the industrial process drawing of FIG. 5.

Glue is applied to the core 12 of the laminated wood product at step 134 of FIG. 4, using a glue machine 234 as shown in the industrial process drawing of FIG. 5.

The opposing surface inner veneers 14 are then pre-pressed onto the opposing surfaces 16 of the core 12 at step 136, using a pre-press machine 236 as shown in the industrial process drawing of FIG. 5.

The core is then inserted into a pre-press machine to be molded and pre-pressed for a preferred time duration of approximately 30 minutes, subject to temperature. Usually, a shorter time duration is required in summer than in winter, the time duration depending on the ambient air temperature, longer time durations being required for lower ambient temperatures and shorter time durations being required for higher ambient temperatures.

The particle board is placed on an adhesive machine after sanding to apply adhesive. Usually the glue must be controlled to 320 g/m2. If the core panel is covered with excess glue when applied, its color will be too dark. To ensure the veneer's color is similar to that of original birch color, and if the birch veneer's production thickness is not thick enough, the veneer will be too thin to screen out viewable particles. But if the birch veneer has a thickness of 0.35 mm, it may still be translucent and can not be fully achieved the desired opacity effect, but opacity can be achieved with the application of two layers of veneer onto the particle board surface, through two layers of birch veneer, which makes the board of the present invention appear substantially similar to natural birch board. Glue must be controlled to reduce excess glue, otherwise a bead shadow will appear when the second veneer is applied.

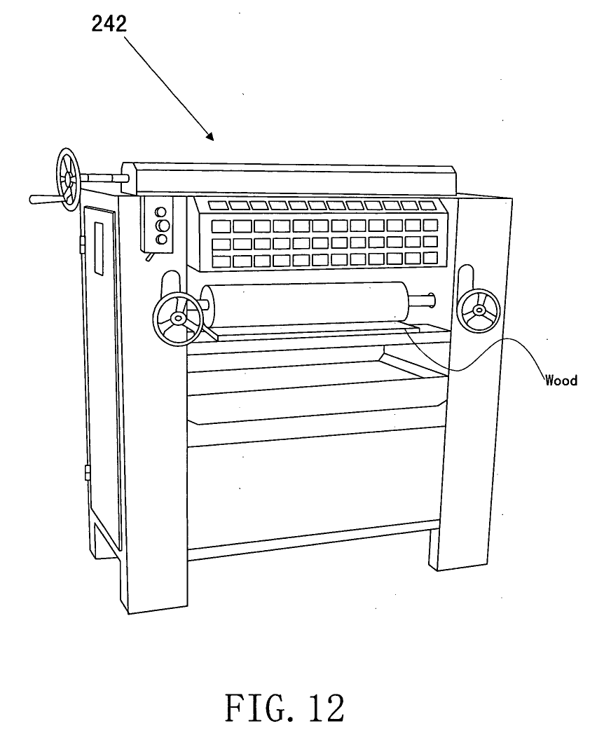

The opposing surface inner veneers 14 are then heat pressed onto the core 12 at step 138 of FIG. 4, using a heat pressing veneering machine 238 as shown in the industrial process drawing of FIG. 5, which is depicted in FIG. 12 as the heat pressing veneering machine 238.

Edges of the opposing surface inner veneers 14 may then be cut at step 140 as shown in FIG. 4A, using a cutter 240 as shown in the industrial process drawing of FIG. 5A.

For first time heat pressing and veneering, pressing temperature is controlled at 110 c-120 c, pressing time has a duration of 5 minutes, during the molding process. After natural cooling, 80 grit sand paper is used to sand the surface of the birch panel and manual repair is done for imperfections which exist, to prevent overlap of joints and cracking. If this happens, then the panel should be repaired with strong glue, otherwise it may negatively affect the application of the second layer of veneer.

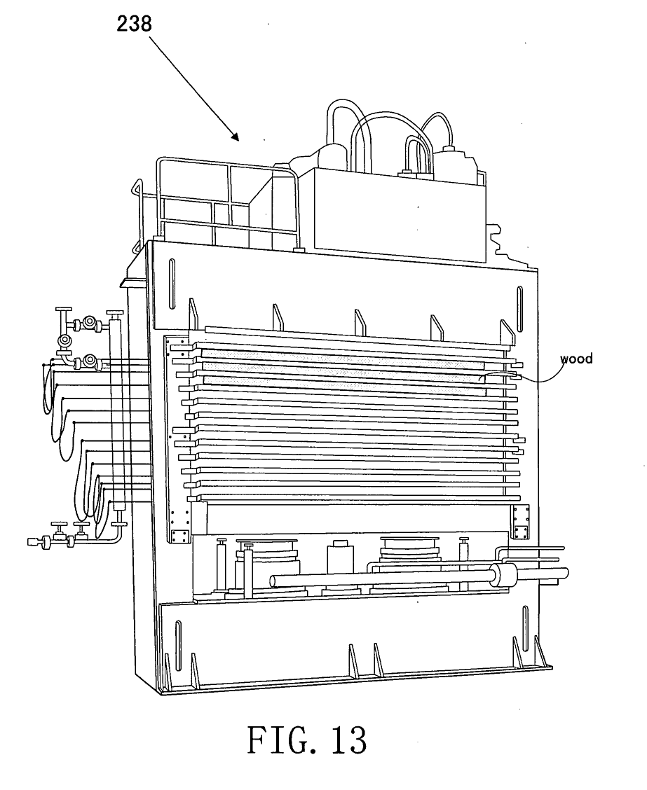

Glue is then applied to the opposing surface inner veneers 14 at step 142 of FIG. 4A, using a glue coating machine 242 as shown in the industrial process drawing of FIG. 5A, which is depicted in FIG. 13 as the glue coating machine 242.

Then again, glue is applied for a second glue coating, the glue used should be controlled at 300 g/m3, to ensure that no excess overglue appears, if this happens the surface of the board will have water-soaked spots and plaque, which may affect the quality of the board.

The opposing surface outer veneers 20 are then pre-pressed onto the opposing surface inner veneers 14 at step 144 of FIG. 4A, using pre-press machine 244 as shown in the industrial process drawing of FIG. 5A.

The opposing surface outer veneers 20 are then pressed onto the opposing surface inner veneers 14 at step 146 of FIG. 4A, using press 246 as shown in the industrial process drawing of FIG. 5A.

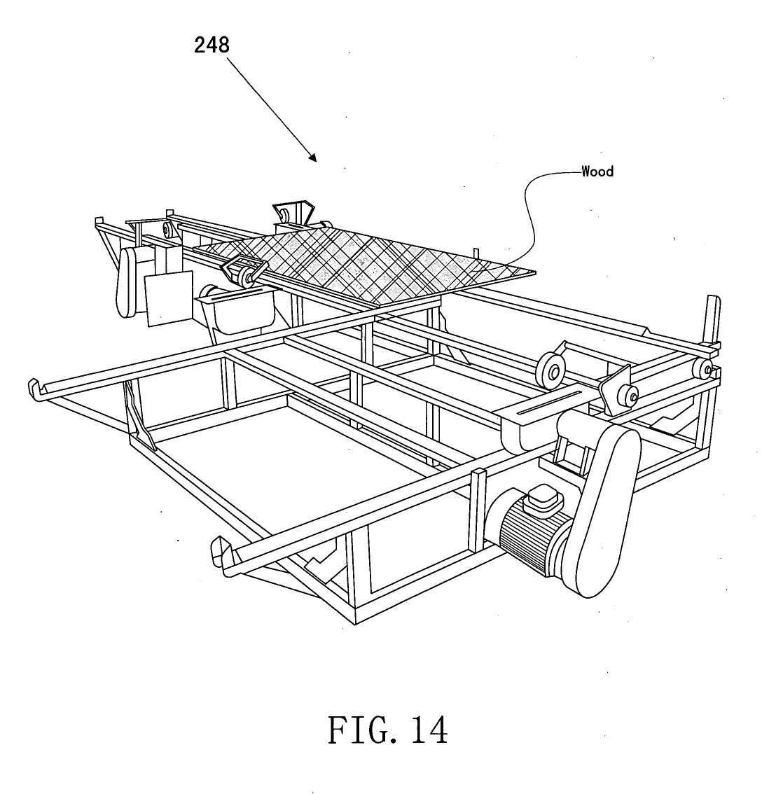

Edges of the opposing surface outer veneers 20 are then cut at step 148 of FIG. 4A, using vertical and horizontal edge cutting machine 248 as shown in the industrial process drawing of FIG. 5A, which is depicted in FIG. 14 as the vertical and horizontal edge cutting machine 248.

To ensure that the panel's length and width meet production requirements, length and width are typically 2440 mm by 1220 mm with a diagonal tolerance error of less than 3 mm. Manual repair may be made with 180 grit sand paper, using a normal sanding machine to polish and obtain a smooth surface, after which a quality birch panel is achieved. This product may be uses as a substitute for birch board used in the fabrication of children's furniture, the molding panel whose cut-off edge up to the required size, may be used by manufacturers to produce furniture and other items. Birch veneer of less than 1.0 mm to 1.22 mm thickness may be applied to the core, using the method of the present invention. Semi-finished products may be sealed and/or edge sealed, using a high-quality edge-sealing machine. Adhesives may be used to apply the veneers and other products with hot melt glue, to achieve a truly similar appearance, touch, and feel of birch wood.

Opposing edge inner veneers 24 and opposing edge outer veneers 30 may be applied to the core 12 and cut in steps similar to the steps used to apply the opposing surface inner veneers 14 to the core 12 and the opposing surface outer veneers 20 onto the opposing surface inner veneers 14 and cut each, as required, which is shown at step 150 of FIG. 4A as shown in the industrial process drawing of FIG. 5A as edge veneer applicator 250.

The laminated core is then sanded at step 152 of FIG. 4A, using sander 252 as shown in the industrial process drawing of FIG. 5A, resulting in the laminated wood product 10.

The laminated wood product 10 may then be optionally painted at step 154 of FIG. 4A, using painter 254 as shown in the industrial process drawing of FIG. 5A, after which the method for manufacturing the laminated wood product 10 typically ends at step 156 of FIG. 4A.

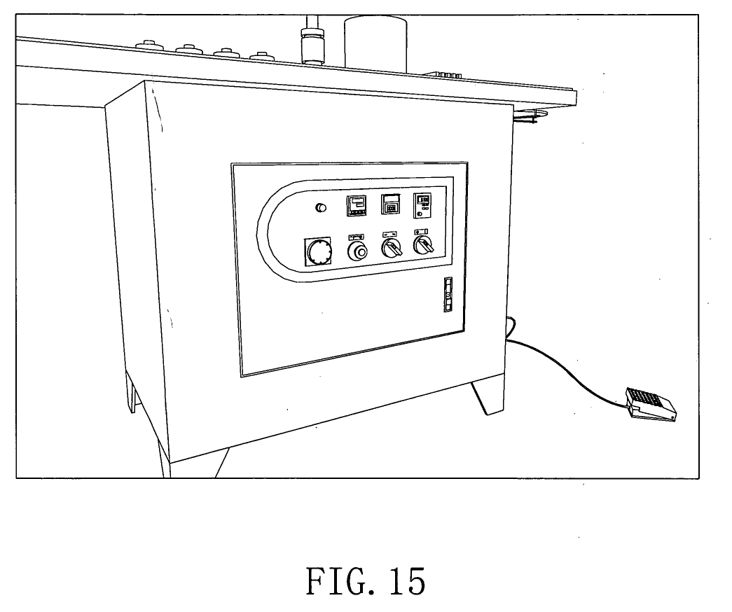

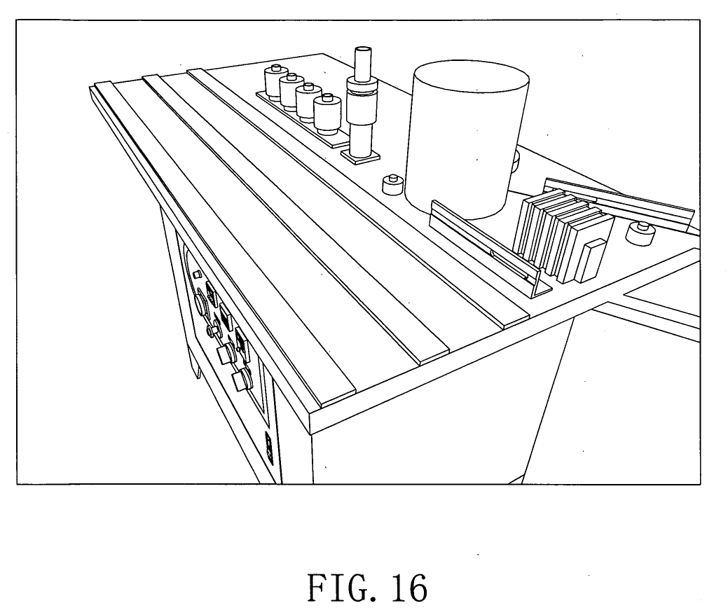

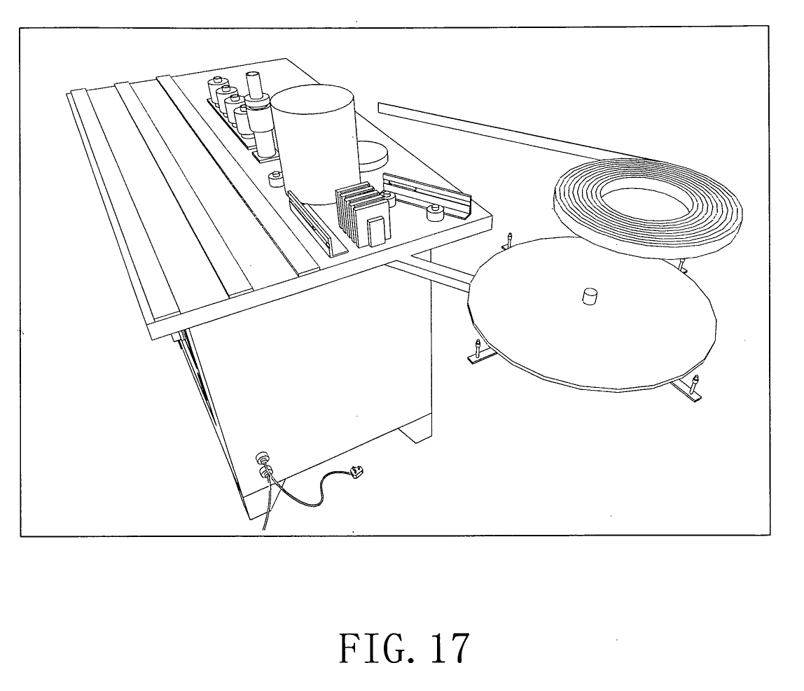

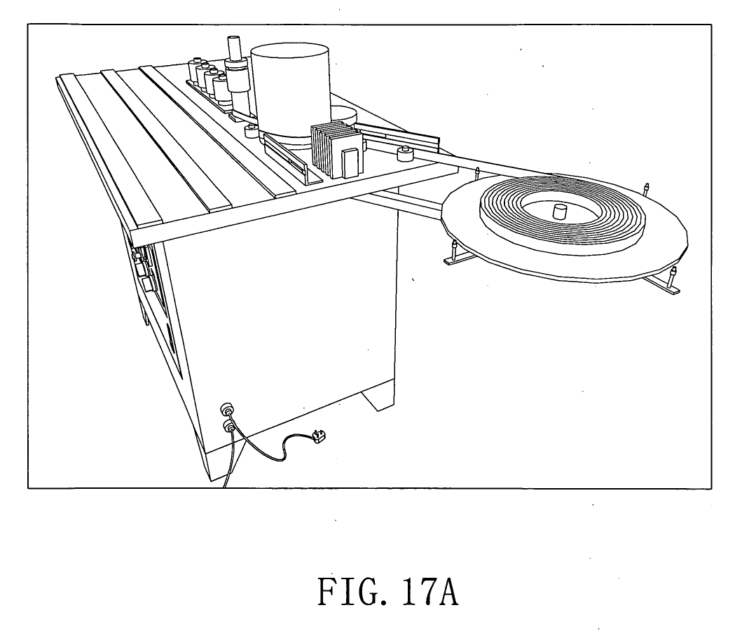

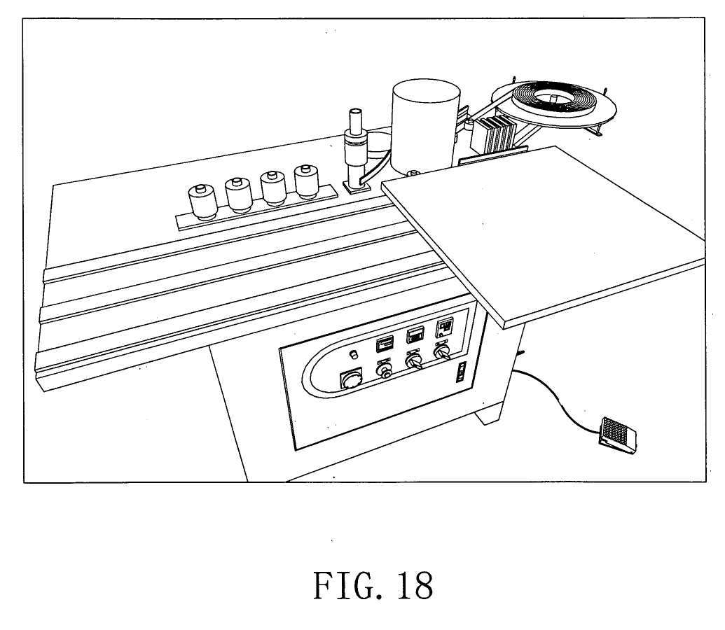

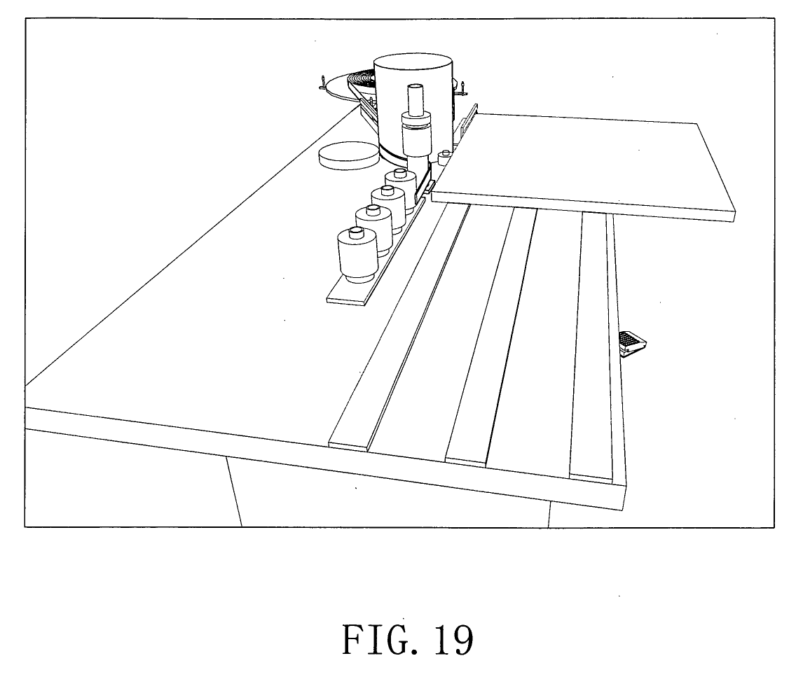

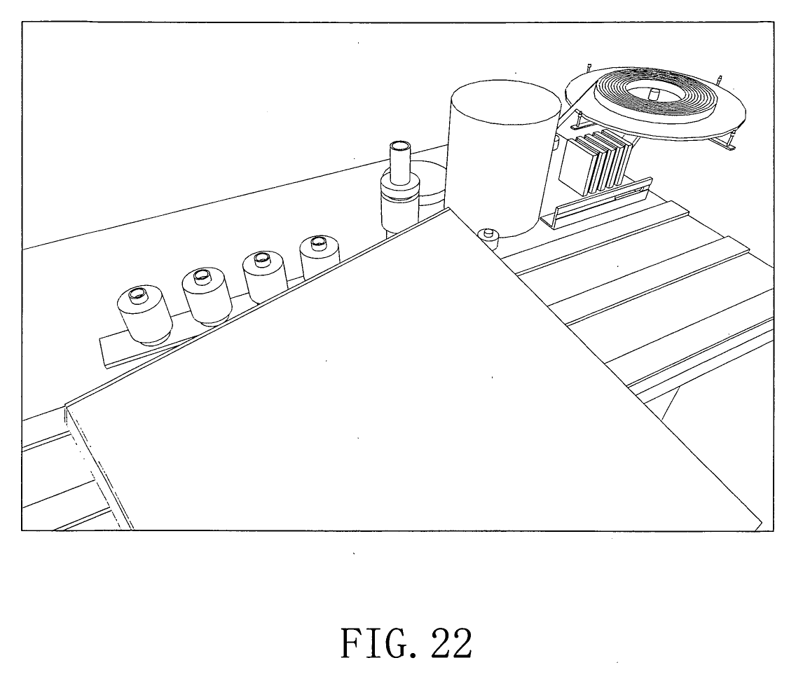

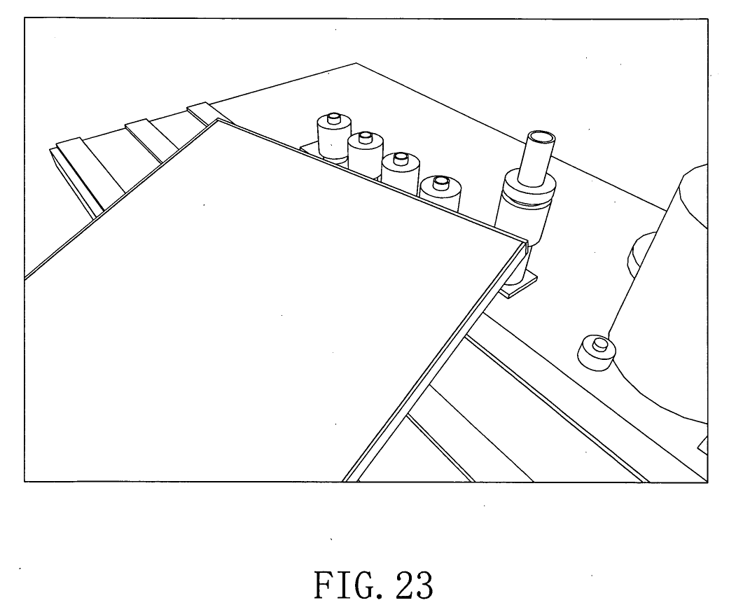

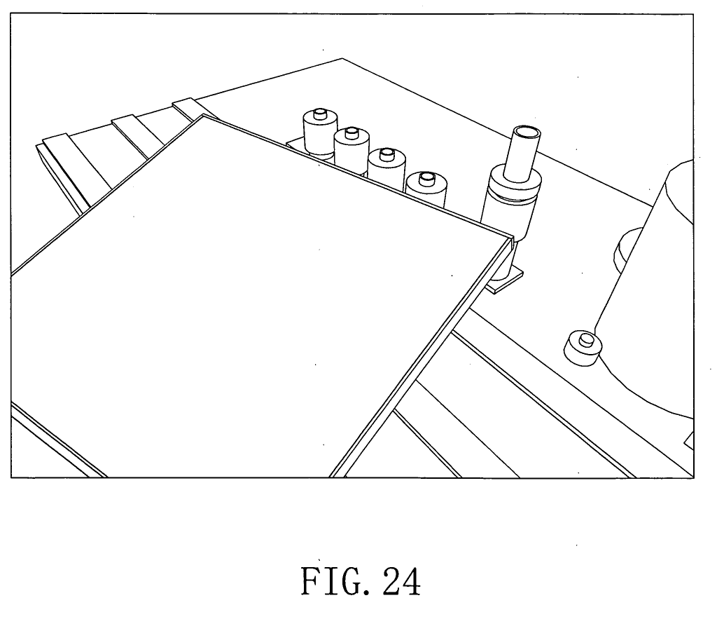

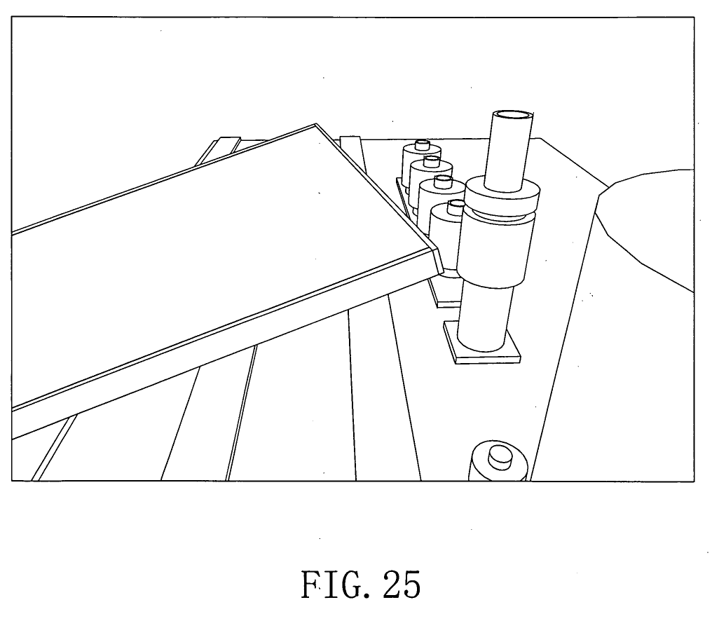

Edge veneers may added to the core, as shown in the FIGS. 15-27. FIG. 15 shows an edge bonding machine. FIG. 16 shows application of hot melt adhesive. FIG. 17 shows edge veneer roller for applying of veneer strips ready to be applied to one of the cores. FIG. 18 shows the core to be laminated with the edge veneer strips. FIGS. 19-21 show the first veneer strip being applied to the laminated core. FIG. 22 shows the finished laminated core having a second veneer strip applied thereto. FIG. 23 shows a third edge veneer strip being applied to edges of one of the cores. FIG. 24 shows the finished edge veneer strip being applied to the edges of one of the cores. FIGS. 25-27 show other perspective views of the finished laminated core having the edge veneer applied thereto. A preferable veneer thickness is 0.5 mm, although veneer thickness may range from 0.3 to 0.5 mm, although other suitable thicknesses may be used.

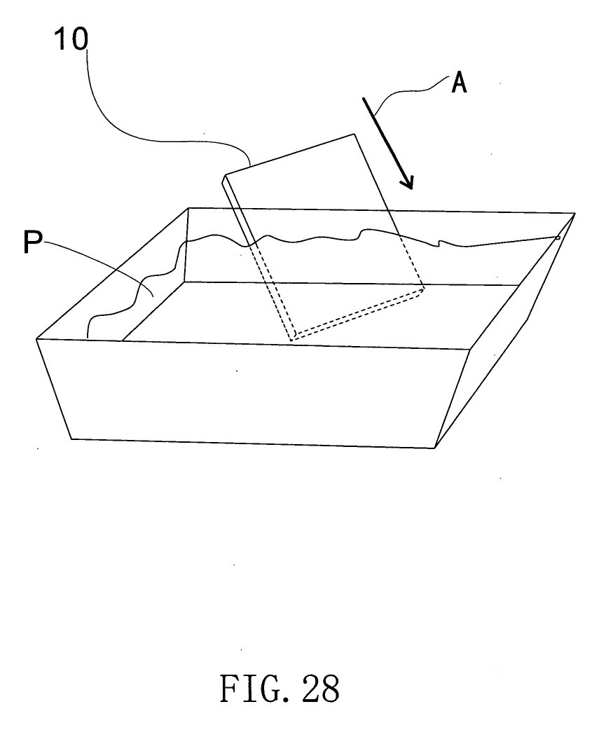

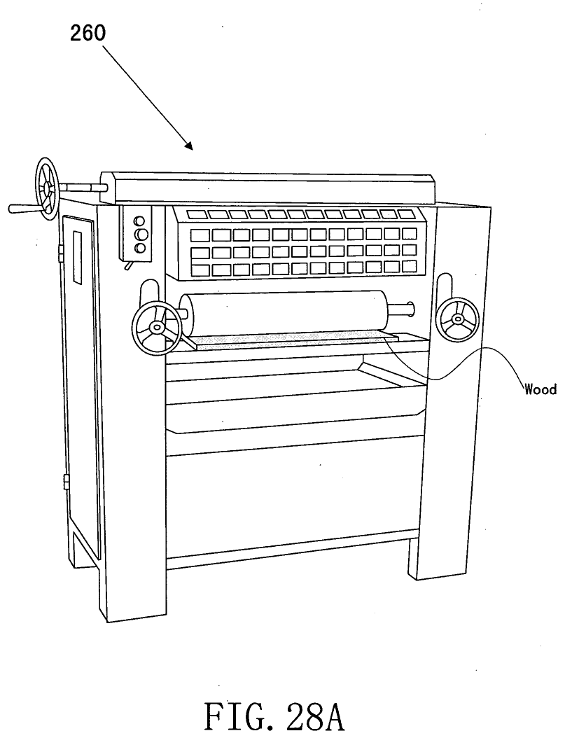

As shown in FIG. 28, the core 12 and/or the laminated wood product 10 may be fireproofed. In a preferred embodiment for manufacturing multi-layer plywood and other suitable products, the core 10 is immersed in fire retardant materials, as part of the method for manufacturing the laminated wood product previously described and shown in FIGS. 3 and 4.

Flame retardants and preservatives are poured into a pool “P”, into which the core 10 is immersed for approximately two hours, and after which time the core 10 is substantially fully soaked in the flame retardants and preservatives. The core 10 is then removed from the pool of flame retardants and preservatives and dried to a moisture content of less than 14 percent to make the core 10 ready for use to make plywood.

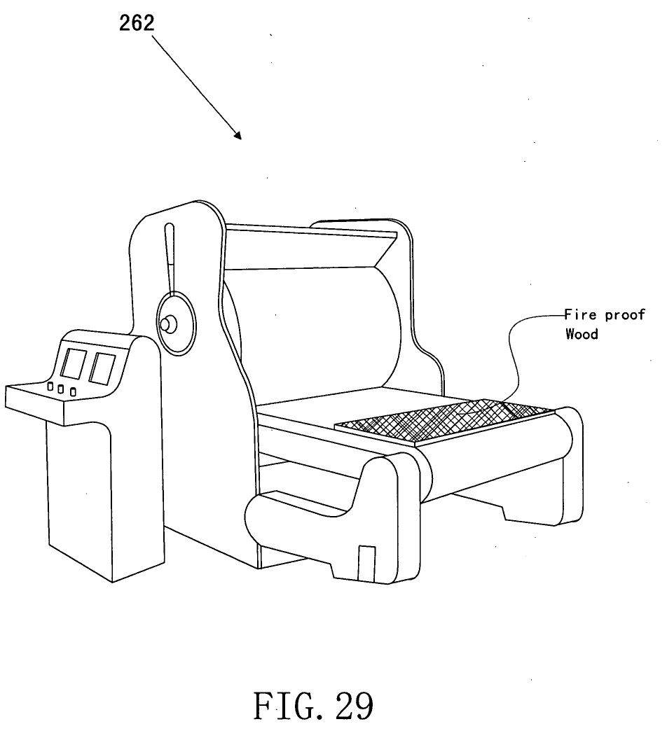

The dried core is then placed in an adhesive coating machine 260 after cooling, the adhesive coating machine 260 shown in FIG. 29. Manual splicing may be performed, in order to achieve desired core sizes after coating. The dried and adhesively coated cores are then cross arranged to fabricate the plywood, as required to meet selected plywood specifications, and when a desired thickness is reached of semi-finished products are reached, the semi-finished product is placed in a pre-press machine 262 for pre-pressing, the pre-press machine 262 shown in FIG. 29. After approximately one hour of pre-pressing, the semi-finished product is transported to a press machine for heating and pressing the semi-finished product into the core in the same manner as shown in the method steps of FIGS. 14-27. The heated and pressed semi-finished product is then cooled, after which time the cooled core is then sanded to substantially constant thickness and flatness, resulting in a thickness tolerance of less than 0.1 mm. The sanded core is then cut into desired sizes, resulting in a fire retardant core having a thickness variation of less than 0.1 mm.

The fire retardant core may alternatively be fabricated by coating the core fire retardant materials and preservatives by spraying or painting the fire retardant materials and preservatives onto the core, using a paint spray gun or a paint brush to reach an immersion depth of at least 2 mm.

If the wood is to be additionally waterproofed or protected from germs, viruses, insect bugs, the wood core 10 is immersed in a fluid which is waterproof, anti-germ, anti-viral and/or anti-insects, in the same pool dipping manner as was done with the fire proof liquid immersion of FIG. 28.

### EXAMPLES

### Example 1

In the U.S. and Europe, the natural color of a natural wood surface having a clear coat with the texture of the wood showing through is highly desirable, especially that of Birch Wood grown in Northern Asia, (Northern China and Russia). Birch wood also has characteristics of surface hardness, beautiful texture, a minimum amount of scar marks, black lines, or mineral lines, does not easily break or change shape after having been cut in the format of veneer sheet (usually in the size of 4 feet by 8 feet, 0.3 mm to 0.5 mm in thickness), but these high quality veneers are becoming less and less available, because a 3 foot or larger diameter birch tree takes more than 60 years to grow, and there are only 3 to 5 sheets of 4 feet by 8 feet veneers in that tree. These 3 to 5 sheets of veneers, may be used on surfaces of 4 feet by 8 feet plywood, and used for the manufacture of 5 storage units for toys. One class room of furniture, however, needs at least 5 times of this amount of veneer, which means that a classroom's furniture needs five birch trees to manufacture the furniture.

### Example 2

The present invention's unique system may be used instead of using birch veneer. Chinese Cottonwood (called Chinese Birch or Chinese beech) which grows on tree farms and takes approximately 7-10 years to grow, and which grows into a one and half foot diameter tree may be used. Veneers from these trees, however, have soft surfaces that may scratch easily. However, such veneers may be hardened by methods of the present invention, resulting in finished products that look substantially the same as Russian Birch, or other highly desired woods.

By using the above wood materials and paint processes of the present invention, wood products can be made completely of recycled wood and veneers from fast growing Chinese trees, thus, minimizing impact to the environment.

### Example 3

### Painting Procedure and Some Background Information

The present invention's unique system may be used instead of using birch veneer. Chinese Cottonwood (called Chinese Birch or Chinese beech) which grows on tree farms and takes approximately 7-10 years to grow, and which grows into a one and half feet wide tree may be used. These veneers, however, have soft surfaces, which are easy to scratch easily, which may be hardened by methods of the present invention.

The painting method and system of the present invention overcomes the aforementioned problems, as follows:

Sand the surface of Chinese Birch veneer first, then use special formula PU (Polyurethane) paint model 1301A, or other suitable paint, as primer or bottom paint; then sand it smooth; apply special formula NC (Nitrocellulose) paint model V1802NC, or other suitable paint, primer or bottom paint; dry it; sand it again; finally apply special formula NC paint finishing model V2104-07, or other suitable paint; dry it; and finish. Paints manufactured by “Shanghai Vision Chemical Co., Ltd.” or other suitable manufacturers may be used.

Using the PU primer can make the surface of Cotton Tree (Chinese Birch or Beech) as hard as that of solid Russian Birch, by painting it with NC bottom paint and once with NC finishing paint, after which process, the finished product looks substantially the same as Russian Birch, since Chinese Birch has a similar surface texture to that of Russian Birch, and it looks very similar to Russian Birch.

Again, by using the above wood materials and paint processes of the present invention, wood products can be made completely of recycled wood and veneers from fast growing Chinese trees, thus, minimizing impact to the environment.

### Example 4

### Other Important Features Include

1. Chips are 3 mm by 3 mm.
2. Glue/wood chips' rate: 28 kg/100 kg under the temperature of 130 C and pressure of 1 cm square/10 kg, in order to achieve the density of 1 m cubic/700 kg.
3. The glue is water proof glue.
4. The thickness of two veneers are: 0.35 mm+0.35 mm, their functions: a) the first layer for covering the blackness of the core layer of chips with glue when paint on the second layer; b) the second layer is for final sanding and painting, in case of sanding too hard, two layers of veneers prevent go through to the core layer to see the blackness and can not apply paint on the surface.
5. When veneers are applied to the core, the temperature is 110 C and pressure of 1 cm square/7-8 kg.

### Example 5

### Water Proof Procedure

1. Add to previous procedure of fabricating core: use water proof glue, to ensure that the core doesn't change its shape and stays straight, if it gets wet.
2. Veneer be applied to the edge procedure: pre-cut veneer is around 1.5 cm width, from 0.5 mm to 1 mm in thickness, and 1 meter or longer length; it is applied using a pressure of over 200 lbs; a hot glue (a kind of glue which after applied, a temperature of more than 200 c degree is required to loosen the veneer) is applied between and edge and glue.

### Example 6

### Fire, Virus/Bug Proof Procedure

1. Use a kind of chemical liquid called: Wood Fire Ruing Resisting Liquid, which makes the wood resistant to fire and bugs and/or viruses.
2. Procedure: Preferably, wood is placed in a tank full of the above mentioned liquid under pressure greater than 1.2 Mp³ for at least 8 hours, which can accept 150 kg/i cube meter into the wood; allow to weep for at least 48 hours, and it can absorb 80-100 kg/l cube meter. Alternatively, the liquid can be applied by brushing the liquid on the surface of the wood three times at least, in order for the wood to absorb at least 0.5 kg/1 cube meter of the liquid.

### Example 7

Various steps in the process, results achieved at certain steps of the process, and various pieces of equipment that may be used in the industrial process for manufacturing the laminated wood product are shown in FIGS. 30-40.

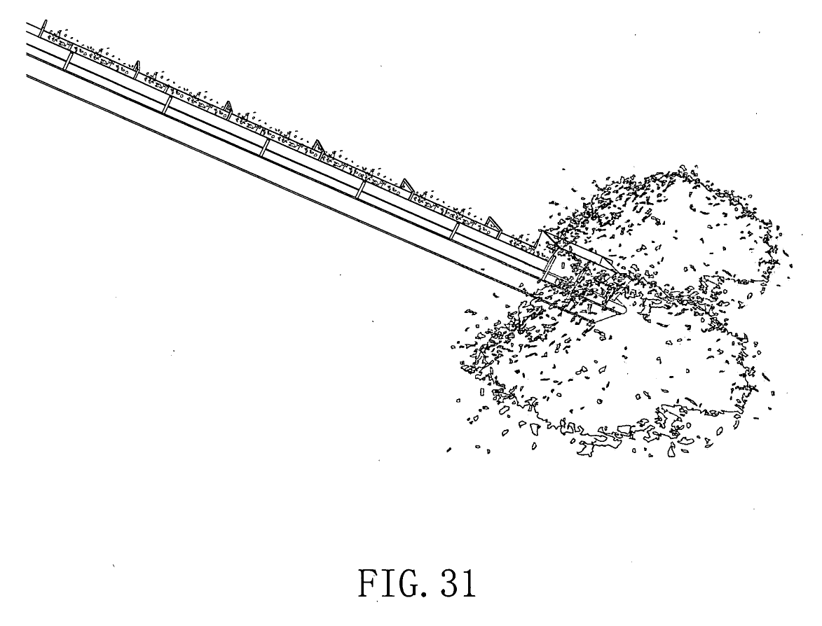

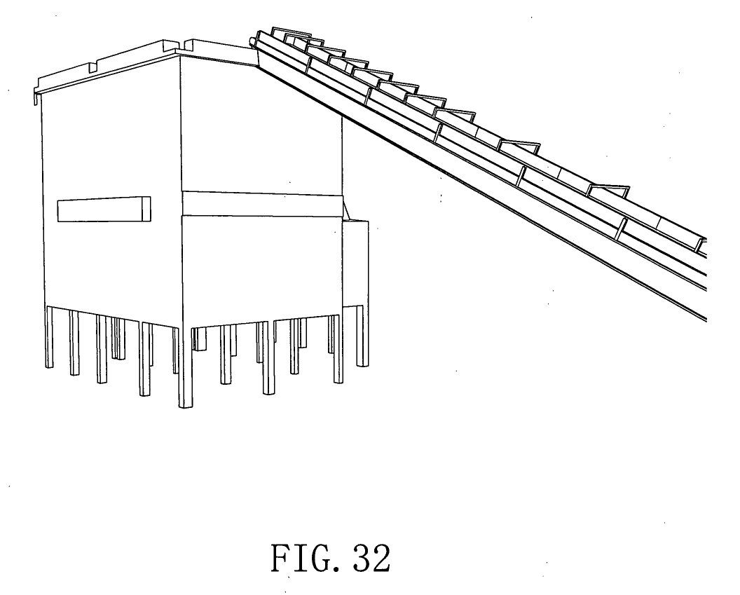

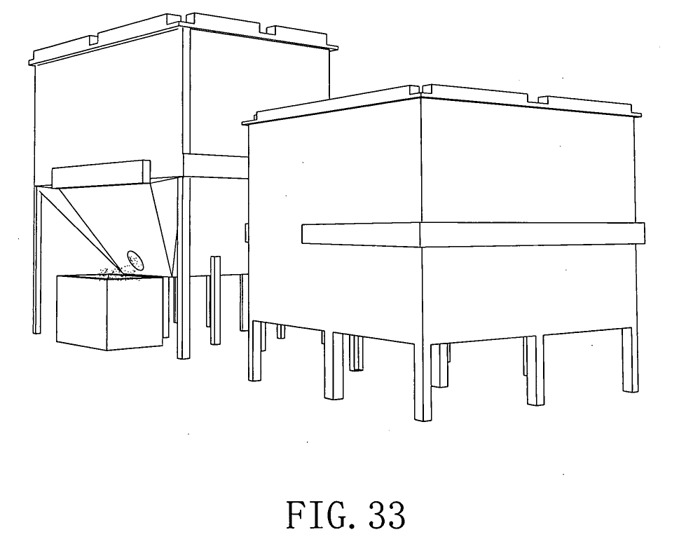

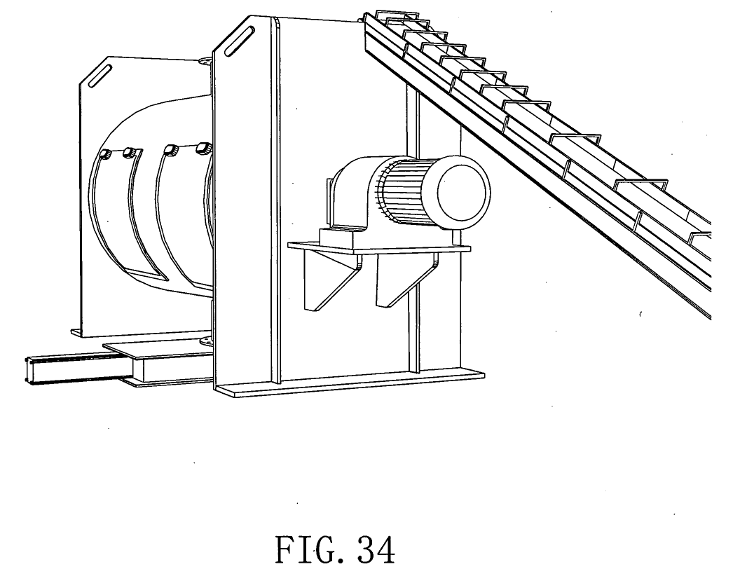

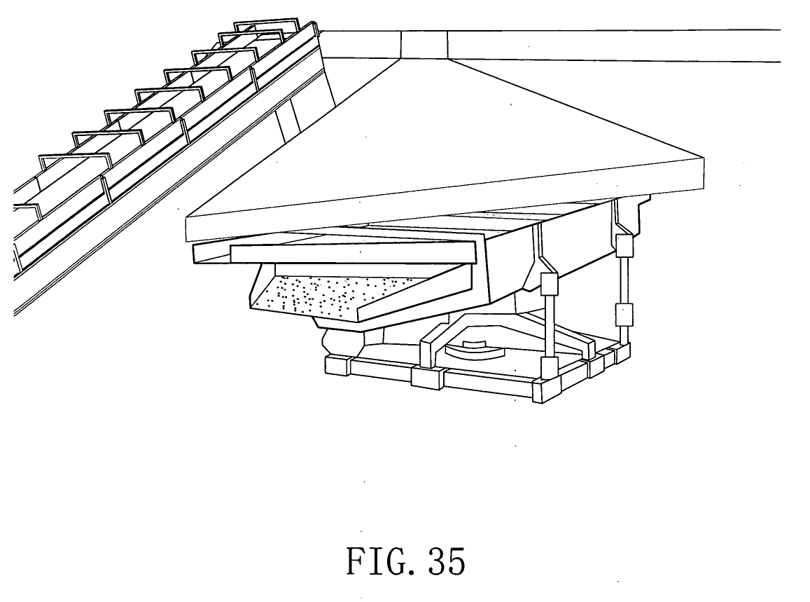

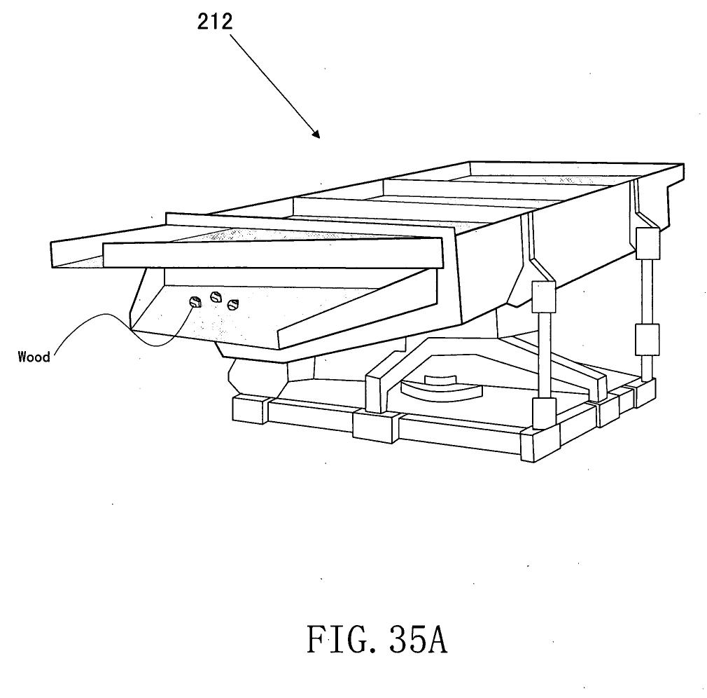

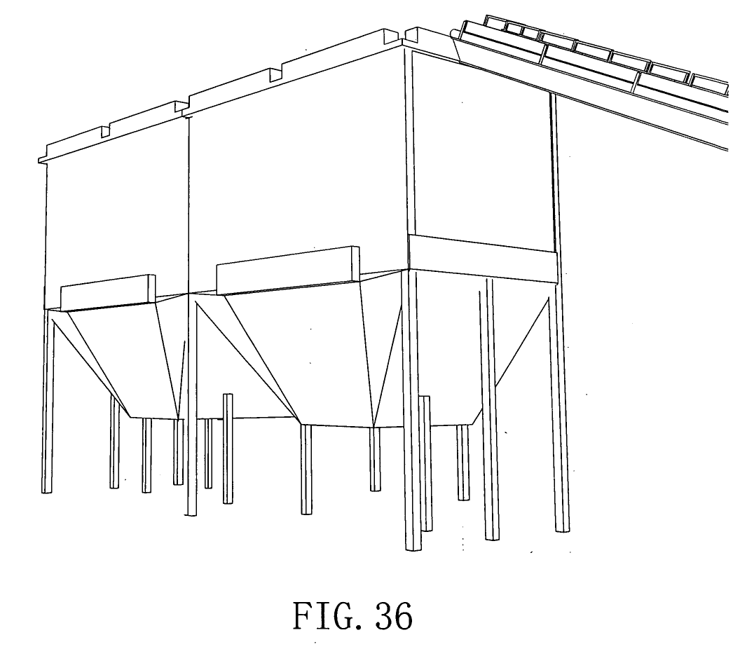

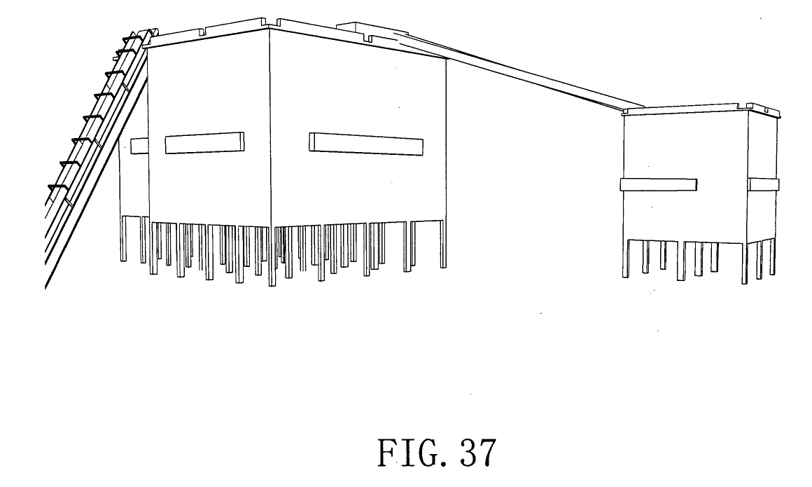

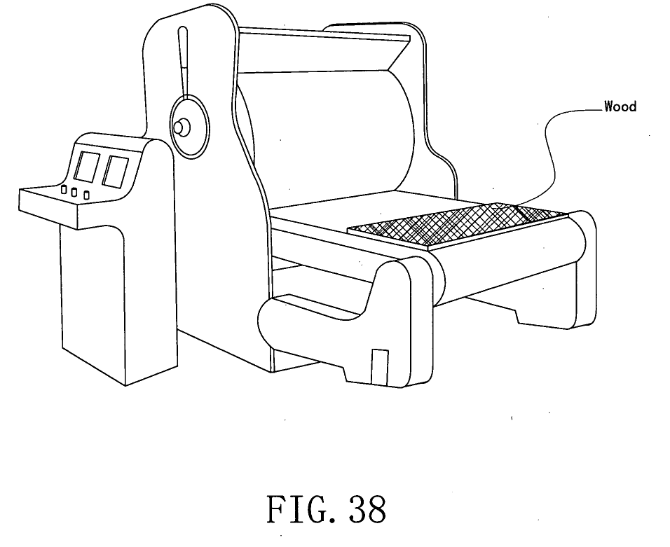

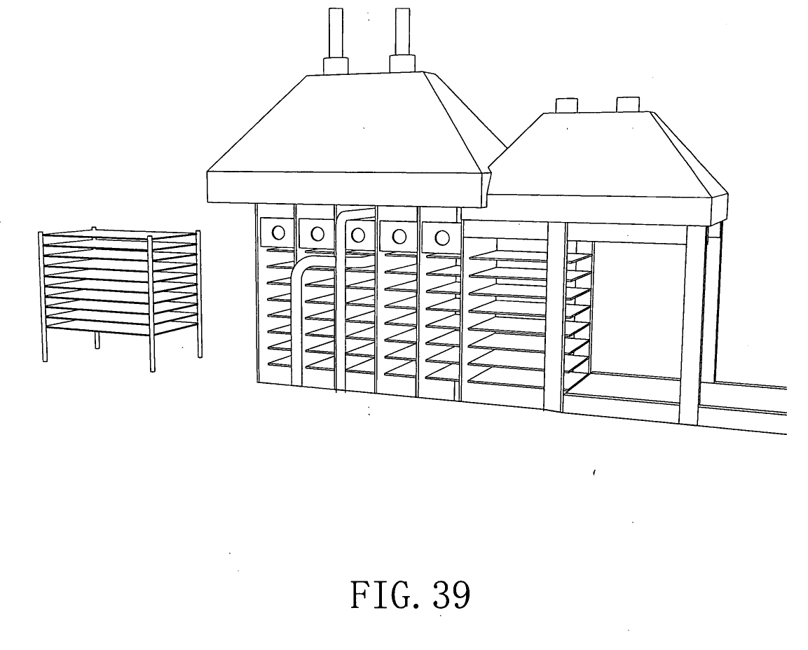

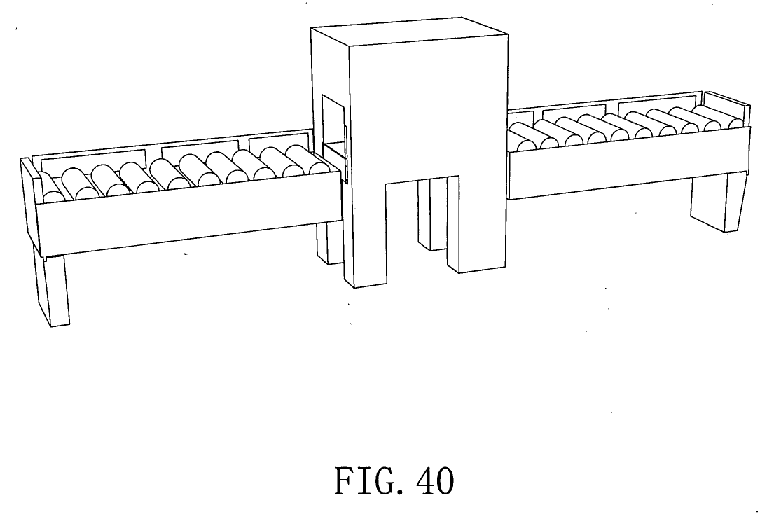

FIG. 30 shows chipped wood of the industrial process for manufacturing the laminated wood product of FIG. 1 that has been chipped down to a maximum size of 3 mm by a wood chipper, such as in step 104 of FIG. 3 or as depicted as wood chipper machine 204 of FIG. 6. FIG. 31 shows the chipped wood being transported on a conveyor belt to a heating and drying machine. FIG. 32 shows a mixer and a conveyor and of the industrial process for manufacturing the laminated wood product of FIG. 1. FIG. 33 shows a mixer of the industrial process for manufacturing the laminated wood product of FIG. 1. FIG. 34 shows a heater-dryer and a conveyor and of the industrial process for manufacturing the laminated wood product of FIG. 1. FIGS. 35 and 35A both show a double swing screen of the industrial process for manufacturing the laminated wood product of FIG. 1. FIG. 36 shows a collector of the industrial process for manufacturing the laminated wood product of FIG. 1. FIG. 37 shows a feeder-spreader of the industrial process for manufacturing the laminated wood product of FIG. 1. FIG. 38 shows a roller plate press machine of the industrial process for manufacturing the laminated wood product of FIG. 1. FIG. 39 shows a pressing machine of the industrial process for manufacturing the laminated wood product of FIG. 1. FIG. 40 shows a sander of the industrial process for manufacturing the laminated wood product of FIG. 1.

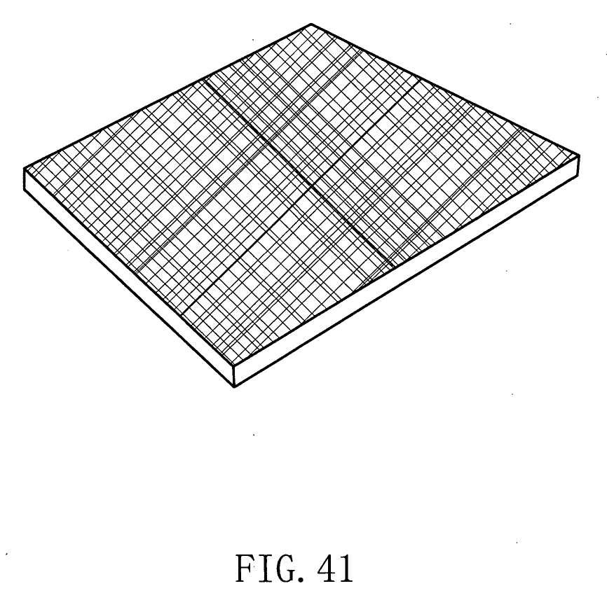

FIG. 41 is a perspective view of a core of an alternate laminated wood product, constructed in accordance with the present invention. FIG. 41 depicts an alternate embodiment for a laminated wood product with longitudinally extending wood strips embedded therein. The longitudinally extending strips embedded in the wood product provide increased strength to the wood product. The core of the alternate laminated wood product of FIG. 41 may be fabricated using wood strips alone or in combination with mixed wood chips and scrapings at steps 106, 108 and 110 of the method 100 for manufacturing the laminated wood product of FIGS. 3,4, and 4A. Wood may be planed into wood strips at step 106 in addition to or in lieu of planing the wood into wood scrapings at step 106. The additional strength to the laminated wood product of the present invention.

Although the present invention has been described in considerable detail with reference to certain preferred versions thereof, other versions are possible. Therefore, the spirit and scope of the appended claims should not be limited to the description of the preferred versions contained herein.

What is claimed is:

1. A process for manufacturing a laminated wood product, comprising at least the following steps:
a) chipping, by a chipper, wood into wood chips;
b) planing, by a planer, other wood into wood scrapings;
c) mixing, by a mixer, the wood chips and the wood scrapings into a mixture of wood chips and wood scrapings;
d) heating and drying, by a heater and dryer, the mixture of wood chips and wood scrapings into a mixture of reduced moisture particles;
e) screening, by a screener, the mixture of reduced moisture particles, into a screened mixture of particles within a predetermined size range;
f) blending and homogenizing, by a blender and homogenizer, the screened mixture of particles into a mixture of blended and homogenized particles;
g) bonding, by a bonder, the blended and homogenized particles into bonded particles;
h) spreading and conveying, by a spreader and conveyor, the bonded particles into a slurry;
i) rolling and pre-pressing, by a roller and pre-presser, the slurry into particle board;
j) cutting, by a cutter, the particle board into cut particle board of a predetermined size;
k) heating and pressing, by a heater and presser, the cut particle board into heated and pressed particle board;
l) cooling, by a cooler, the heated and pressed particle board into cooled particle board;
m) sanding, by a sander, the cooled particle board to core particle board of predetermined thickness;
n) applying, by an applicator, bonding material to the core particle board;
o) pre-pressing, by a pre-presser, a first veneer onto the applied bonding material of the core particle board, resulting in pre-pressed first veneer laminated wood product;
p) heat pressing, by a heat presser, the pre-pressed first veneer laminated wood product into heat pressed first veneer laminated wood product;
q) cutting, by a first veneer cutter, edges of the first veneer of the heat pressed first veneer laminated wood product, resulting in trimmed first veneer laminated wood product;
r) applying, by another applicator, additional bonding material to the first veneer of the trimmed first veneer laminated wood product;
s) pre-pressing, by another pre-presser, a second veneer onto the applied additional bonding material of the trimmed first veneer laminated wood product, resulting in pre-pressed first and second veneer laminated wood product;
t) pressing, by a presser, the pre-pressed first and second veneer laminated wood product into pressed first and second veneer laminated wood product;
u) cutting, by a second veneer cutter, edges of the second veneer of the pressed first and second veneer laminated wood product, resulting in trimmed first and second veneer laminated wood product;
v) applying, by an edge veneer applicator, edge veneer to edges of the trimmed first and second veneer laminated wood product, resulting in a veneered laminated wood product;
w) sanding and smoothing, by a sander and smoother, the veneered laminated wood product into the laminated wood product.

2. The process for manufacturing a laminated wood product of claim 1, further comprising the following step:
x) painting, by a painter, the laminated wood product into painted laminated wood product.

3. The process for manufacturing a laminated wood product of claim 1, wherein step b) further comprises:
planing, by the planer, the other wood into wood strips

4. The process for manufacturing a laminated wood product of claim 1, wherein the wood scrapings of step b) comprise wood strips.

5. The process for manufacturing a laminated wood product of claim 1, wherein the predetermined size range of the screened mixture of particles of step e) comprises particles of less than five millimeters.

6. The process for manufacturing a laminated wood product of claim 1, wherein the bonding, by the bonder, the blended and homogenized particles into the bonded particles of step g) comprises bonding the blended and homogenized particles into the bonded particles with glue.

7. The process for manufacturing a laminated wood product of claim 6, wherein the glue comprises urea-formaldehyde glue.

8. The process for manufacturing a laminated wood product of claim 6, wherein the glue comprises El urea-formaldehyde glue having formaldehyde emission of less than or equal to 9 mg/100 g.

9. The process for manufacturing a laminated wood product of claim 5, wherein the bonding, by the bonder, the blended and homogenized particles into the bonded particles of step g) comprises bonding the blended and homogenized particles into the bonded particles with El urea-formaldehyde glue having formaldehyde emission of less than or equal to 9 mg/100 g.

10. The process for manufacturing a laminated wood product of claim 1, wherein the predetermined size range of the screened mixture of particles of step e) comprises particles of less than three millimeters.

11. The process for manufacturing a laminated wood product of claim 10, wherein the bonding, by the bonder, the blended and homogenized particles into the bonded particles of step g) comprises bonding the blended and homogenized particles into the bonded particles with El urea-formaldehyde glue having formaldehyde emission of less than or equal to 9 mg/100 g.

12. The process for manufacturing a laminated wood product of claim 1, wherein the mixture of reduced moisture particles comprises a moisture content of less than 12 percent.

13. The process for manufacturing a laminated wood product of claim 9, wherein the mixture of reduced moisture particles comprises a moisture content of less than twelve percent.

14. The process for manufacturing a laminated wood product of claim 8, wherein the El urea-formaldehyde glue is mixed with the mixture of blended and homogenized particles at a ratio of ten kilograms to twelve kilograms of the El urea-formaldehyde glue per one hundred kilograms of the mixture of blended and homogenized particles.

15. The process for manufacturing a laminated wood product of claim 13, wherein the El urea-formaldehyde glue is mixed with the mixture of blended and homogenized particles at a ratio of approximately ten kilograms to twelve kilograms of the El urea-formaldehyde glue per one hundred kilograms of the mixture of blended and homogenized particles.

16. The process for manufacturing a laminated wood product of claim 13, wherein the core particle board has a density greater than 0.8 grams per cubic centimeter

17. The process for manufacturing a laminated wood product of claim 1, wherein the wood and/or the other wood are from the group consisting of: wood, fresh wood, green wood, recycled wood, recycled wood products, waste wood, scrap wood, saw dust, wood tree branches, wood sticks, and any combination of one or more thereof.

18. An apparatus for manufacturing a laminated wood product, comprising:
a) a chipper chipping, by the chipper, wood into wood chips;
b) a planer planing, by the planer, other wood into wood scrapings;
c) a mixer mixing, by the mixer, the wood chips and the wood scrapings into a mixture of wood chips and wood scrapings;
d) a heater and dryer heating and drying, by the heater and dryer, the mixture of wood chips and wood scrapings into a mixture of reduced moisture particles;
e) a screener screening, by the screener, the mixture of reduced moisture particles, into a screened mixture of particles within a predetermined size range;
f) a blender and homogenizer blending and homogenizing, by the blender and homogenizer, the screened mixture of particles into a mixture of blended and homogenized particles;
g) a bonder bonding, by the bonder, the blended and homogenized particles into bonded particles;
h) a spreader and conveyor spreading and conveying, by the spreader and conveyor, the bonded particles into a slurry;
i) a roller and pre-presser rolling and pre-pressing, by the roller and pre-presser, the slurry into particle board;
j) a cutter cutting, by the cutter, the particle board into cut particle board of a predetermined size;
k) a heater and presser heating and pressing, by the heater and presser, the cut particle board into heated and pressed particle board;
l) a cooler cooling, by the cooler, the heated and pressed particle board into cooled particle board;
m) a sander sanding, by the sander, the cooled particle board to core particle board of predetermined thickness;
n) an applicator applying, by the applicator, bonding material to the core particle board;
o) a pre-presser pre-pressing, by the pre-presser, a first veneer onto the applied bonding material of the core particle board, resulting in pre-pressed first veneer laminated wood product;
p) a heat presser heat pressing, by the heat presser, the pre-pressed first veneer laminated wood product into heat pressed first veneer laminated wood product;
q) a first veneer cutter cutting, by the first veneer cutter, edges of the first veneer of the heat pressed first veneer laminated wood product, resulting in trimmed first veneer laminated wood product;
r) another applicator applying, by the other applicator, additional bonding material to the first veneer of the trimmed first veneer laminated wood product;
s) another pre-presser pre-pressing, by the other pre-presser, a second veneer onto the applied additional bonding material of the trimmed first veneer laminated wood product, resulting in pre-pressed first and second veneer laminated wood product;
t) a presser pressing, by the presser, the pre-pressed first and second veneer laminated wood product into pressed first and second veneer laminated wood product;
u) a second veneer cutter cutting, by the second veneer cutter, edges of the second veneer of the pressed first and second veneer laminated wood product, resulting in trimmed first and second veneer laminated wood product;
v) an edge veneer applicator applying, by the edge veneer applicator, edge veneer to edges of the trimmed first and second veneer laminated wood product, resulting in a veneered laminated wood product;
w) a sander and smoother sanding and smoothing, by the sander and smoother, the veneered laminated wood product into the laminated wood product.

19. The apparatus for manufacturing a laminated wood product of claim 18, wherein the wood scrapings comprise wood strips.

20. A process for manufacturing a laminated wood product, comprising at least the following steps:
a) chipping, by a chipper, wood into wood chips;
b) planing, by a planer, other wood into wood scrapings;
c) mixing, by a mixer, the wood chips and the wood scrapings into a mixture of wood chips and wood scrapings;
d) heating and drying, by a heater and dryer, the mixture of wood chips and wood scrapings into a mixture of reduced moisture particles;
e) screening, by a screener, the mixture of reduced moisture particles, into a screened mixture of particles within a predetermined size range;
f) blending and homogenizing, by a blender and homogenizer, the screened mixture of particles into a mixture of blended and homogenized particles;
g) bonding, by a bonder, the blended and homogenized particles into bonded particles;
h) spreading and conveying, by a spreader and conveyor, the bonded particles into a slurry;
i) rolling and pre-pressing, by a roller and pre-presser, the slurry into particle board;
j) cutting, by a cutter, the particle board into cut particle board of a predetermined size;
k) heating and pressing, by a heater and presser, the cut particle board into heated and pressed particle board;
l) cooling, by a cooler, the heated and pressed particle board into cooled particle boar d;
m) sanding, by a sander, the cooled particle board to core particle board of predetermined thickness;
n) applying, by an applicator, bonding material to the core particle board;
o) pre-pressing, by a pre-presser, a first veneer onto the applied bonding material of the core particle board, resulting in pre-pressed first veneer laminated wood product;
p) heat pressing, by a heat presser, the pre-pressed first veneer laminated wood product into heat pressed first veneer laminated wood product;
q) cutting, by a first veneer cutter, edges of the first veneer of the heat pressed first veneer laminated wood product, resulting in trimmed first veneer laminated wood product.

21. The process for manufacturing a laminated wood product of claim 20, further comprising the following step:
r) sanding and smoothing, by a sander and smoother, the trimmed first veneer laminated wood product into the laminated wood product.

22. The process for manufacturing a laminated wood product of claim 21, further comprising the following step:
s) painting, by a painter, the laminated wood product into painted laminated wood product.

23. The process for manufacturing a laminated wood product of claim 20, further comprising the following steps:
r) applying, by another applicator, additional bonding material to the first veneer of the trimmed first veneer laminated wood product;
s) pre-pressing, by another pre-presser, a second veneer onto the applied additional bonding material of the trimmed first veneer laminated wood product, resulting in pre-pressed first and second veneer laminated wood product;
t) pressing, by a presser, the pre-pressed first and second veneer laminated wood product into pressed first and second veneer laminated wood product;
u) cutting, by a second veneer cutter, edges of the second veneer of the pressed first and second veneer laminated wood product, resulting in trimmed first and second veneer laminated wood product;
v) sanding and smoothing, by a sander and smoother, the trimmed first and second veneer laminated wood product into the laminated wood product.

24. The process for manufacturing a laminated wood product of claim 23, further comprising the following step:
w) painting, by a painter, the laminated wood product into painted laminated wood product.

25. The process for manufacturing a laminated wood product of claim 20, wherein the wood scrapings of step b) comprise wood strips.

26. An apparatus for manufacturing a laminated wood product, comprising:
a) a chipper chipping, by the chipper, wood into wood chips;
b) a planer planing, by the planer, other wood into wood scrapings;
c) a mixer mixing, by the mixer, the wood chips and the wood scrapings into a mixture of wood chips and wood scrapings;
d) a heater and dryer heating and drying, by the heater and dryer, the mixture of wood chips and wood scrapings into a mixture of reduced moisture particles;
e) a screener screening, by the screener, the mixture of reduced moisture particles, into a screened mixture of particles within a predetermined size range;
f) a blender and homogenizer blending and homogenizing, by the blender and homogenizer, the screened mixture of particles into a mixture of blended and homogenized particles;
g) a bonder bonding, by the bonder, the blended and homogenized particles into bonded particles;
h) a spreader and conveyor spreading and conveying, by the spreader and conveyor, the bonded particles into a slurry;
i) a roller and pre-presser rolling and pre-pressing, by the roller and pre-presser, the slurry into particle board;
j) a cutter cutting, by the cutter, the particle board into cut particle board of a predetermined size;
k) a heater and presser heating and pressing, by the heater and presser, the cut particle board into heated and pressed particle board;
l) a cooler cooling, by the cooler, the heated and pressed particle board into cooled particle board;
m) a sander sanding, by the sander, the cooled particle board to core particle board of predetermined thickness;
n) an applicator applying, by the applicator, bonding material to the core particle board;
o) a pre-presser pre-pressing, by the pre-presser, a first veneer onto the applied bonding material of the core particle board, resulting in pre-pressed first veneer laminated wood product;
p) a heat presser heat pressing, by the heat presser, the pre-pressed first veneer laminated wood product into heat pressed first veneer laminated wood product;
q) a first veneer cutter cutting, by the first veneer cutter, edges of the first veneer of the heat pressed first veneer laminated wood product, resulting in trimmed first veneer laminated wood product.

27. The apparatus for manufacturing a laminated wood product of claim 26, further comprising:
r) a sander and smoother sanding and smoothing, by the sander and smoother, the trimmed first veneer laminated wood product into the laminated wood product.

28. The apparatus for manufacturing a laminated wood product of claim 27, further comprising:
s) a painter painting, by the painter, the laminated wood product into painted laminated wood product.

29. The apparatus for manufacturing a laminated wood product of claim 26, further comprising:
r) another applicator applying, by the other applicator, additional bonding material to the first veneer of the trimmed first veneer laminated wood product;
s) another pre-presser pre-pressing, by the other pre-presser, a second veneer onto the applied additional bonding material of the trimmed first veneer laminated wood product, resulting in pre-pressed first and second veneer laminated wood product;
t) a presser pressing, by the presser, the pre-pressed first and second veneer laminated wood product into pressed first and second veneer laminated wood product;
u) a second veneer cutter cutting, by the second veneer cutter, edges of the second veneer of the pressed first and second veneer laminated wood product, resulting in trimmed first and second veneer laminated wood product;
v) a sander and smoother sanding and smoothing, by the sander and smoother, the trimmed first and second veneer laminated wood product into the laminated wood product.

30. The apparatus for manufacturing a laminated wood product of claim 26, wherein the wood scrapings comprise wood strips.

31. A laminated wood product, comprising:
a wood particle board comprising an aggregate of wood chip particles, each wood chip particle of said aggregate of wood chip particles being at least 1.0 mm and less than 5.0 mm in length, depth and width;
said wood chip particles being separated by space filled by resin glue;
said wood chip particles and resin glue being provided by weight in a wood chip particle to resin glue ratio of between 100:10 to up to a maximum of 100:28;
said wood particle board having a density of about 0.8 g/cm³, and,
at least one exterior wood veneer layer on at least one surface of said laminate panel, said at least one exterior wood veneer layer having a thickness provided in a range of about 0.30 to about 0.70 millimeters in thickness.

32. The laminated wood product as in claim 31, wherein said resin glue is applied in the ratio of 320 g/m².

33. The laminated wood product as in claim 31, wherein said at least one wood veneer layer is heat treated and pressure treated at a temperature of about 110 degrees C. and pressure of about 7-8 kg per cm².

34. The laminated wood product as in claim 31, wherein said at least one exterior wood veneer layer is provided on at least one respective edge of said wood particle board in a range of about at least 1.5 cm in width, 0.5 to about 1 mm in thickness, and at least one meter in length.

35. The laminated wood product as in claim 31, wherein said at least one exterior wood veneer layer is applied to said at least one respective edge of said wood particle board with said resin glue at a pressure of about 200 pounds and at approximately 200 degrees C. heat.

36. The laminated wood product as in claim 31, wherein a thin layer of wood fire resisting liquid is applied to said laminated wood product by immersion of said laminated wood product in said wood fire resisting liquid at a pressure of greater than 1.2 Mp³P for at least 8 hours immersion.

37. The laminated wood product as in claim 31, wherein said at least one exterior wood veneer layer comprises a plurality of wood veneer surface layers.

38. The laminated wood product as in claim 31, wherein said at least one exterior wood veneer layer is a plurality of wood veneer surface layers, which are layered one upper surface wood veneer layer above another adjacent lower wood veneer surface layer.

39. The laminated wood product as in claim 31, wherein said at least one exterior wood veneer layer has a thickness in a range of from 0.3 to 0.5 mm in thickness.

40. The laminated wood product as in claim 39, wherein said at least one exterior wood veneer layer has a thickness of less than or equal to about 0.5 mm in thickness.

41. The laminated wood product as in claim 31, wherein said wood chip particles are each provided in a range of about 3.0-5.0 mm in length, depth and width.

42. The laminated wood product as in claim 31, wherein said wood particle board further comprises a plurality of longitudinally extending wood strips in a matrix therein.

43. The laminated wood product as in claim 31, wherein said wood chip particles comprises a plurality of longitudinally extending wood strips in a matrix therein.
